(19) United States
(12) Patent Application Publication
(10) Pub. No.: US 2022/0121092 A1
(43) Pub. Date: Apr. 21, 2022

(54) PROJECTION APPARATUS

(71) Applicant: SEIKO EPSON CORPORATION, Tokyo (JP)

(72) Inventors: Nobuyuki OTSUKI, Matsumoto-shi (JP); Makoto ZAKOJI, Matsumoto-shi (JP); Katsunori TANAKA, Azumino-shi (JP)

(21) Appl. No.: 17/502,442

(22) Filed: Oct. 15, 2021

(30) Foreign Application Priority Data
Oct. 16, 2020 (JP) 2020-174989

(51) Int. Cl. G03B 21/16; G03B 21/14; G03B 21/20

(52) U.S. Cl. CPC G03B 21/16; G03B 21/2033; G03B 21/142

(57) ABSTRACT

A projection apparatus includes a projection optical apparatus having an entrance optical path that image light enters and a passage optical path that is a deflected extension of the entrance optical path, an image generation apparatus that causes the image light to enter the entrance optical path, a light source apparatus that supplies the image generation apparatus with illumination light, and a first apparatus disposed on the opposite side of the projection optical apparatus from the light source apparatus, and the first apparatus is at least one of a controller and a power supply.

The present application is based on, and claims priority from JP Application Serial Number 2020-174989, filed Oct. 16, 2020, the disclosure of which is hereby incorporated by reference herein in its entirety.

### BACKGROUND

### 1. Technical Field

The present disclosure relates to a projection apparatus.

### 2. Related Art

There has been a known projector that modulates the light outputted from a light source apparatus and projects the modulated light. As a projector of this type, there is a known liquid crystal projector including a light source unit, an optical unit, a projection lens, and a power supply (see, JP-A-2004-133304, for example).

In the liquid crystal projector described in JP-A-2004-133304, the projection lens is provided substantially at the center of the liquid crystal projector in the rightward-leftward direction. The optical unit is disposed in a position shifted from the projection lens toward the rear side of the liquid crystal projector and modulates illumination light incident from the light source unit. The light source unit is disposed in a position shifted in a direction perpendicular to the direction in which the projection lens and optical unit are arranged and outputs the illumination light to the optical unit. The power supply is disposed on the opposite side of the projection lens and optical unit from the light source unit.

In the liquid crystal projector described in JP-A-2004-133304, however, the optical unit is disposed in a position shifted from the projection lens toward the rear surface. In detail, when the liquid crystal projector is viewed from above, the optical unit is disposed in a position shifted from the projection lens in the frontward-rearward direction of the liquid crystal projector out of the directions perpendicular to the direction in which the light source unit and the power supply are coupled to each other. The configuration described above causes a problem of a difficulty in reducing the dimensions of the liquid crystal projector in the frontward-rearward direction.

There has therefore been a demand for a configuration that allows reduction in size of a projection apparatus.

### SUMMARY

A projection apparatus according to an aspect of the present disclosure includes a projection optical apparatus having an entrance optical path that image light enters and a passage optical path that is a deflected extension of the entrance optical path, an image generation apparatus that causes the image light to enter the entrance optical path, a light source apparatus that supplies the image generation apparatus with illumination light, and a first apparatus disposed on an opposite side of the projection optical apparatus from the light source apparatus, and the first apparatus is at least one of a controller and a power supply.

### BRIEF DESCRIPTION OF THE DRAWINGS

FIG. 1 is a perspective view showing the exterior appearance of a projector according to a first embodiment.

FIG. 2 is another perspective view showing the exterior appearance of the projector according to the first embodiment.

FIG. 3 shows the internal configuration of the projector according to the first embodiment.

FIG. 4 is a diagrammatic view showing the configuration of an image projection apparatus according to the first embodiment.

FIG. 5 shows a light source section according to the first embodiment.

FIG. 6 is a cross-sectional view showing the projector according to the first embodiment.

FIG. 7 shows the internal configuration of the projector according to the first embodiment.

FIG. 8 is a perspective view showing the internal configuration of the projector according to the first embodiment.

FIG. 9 shows a cross section of the projector taken along the line IX-IX in FIG. 3.

FIG. 10 is a diagrammatic view showing a first variation of the image projection apparatus according to the first embodiment.

FIG. 11 is a diagrammatic view showing a second variation of the image projection apparatus according to the first embodiment.

FIG. 12 is a diagrammatic view showing a third variation of the image projection apparatus according to the first embodiment.

FIG. 13 is a diagrammatic view showing a fourth variation of the image projection apparatus according to the first embodiment.

FIG. 14 is a diagrammatic view showing a fifth variation of the image projection apparatus according to the first embodiment.

FIG. 15 shows the internal configuration of the projector according to a second embodiment.

FIG. 16 is a perspective view showing the exterior appearance of the projector according to a third embodiment.

FIG. 17 shows the internal configuration of the projector according to the third embodiment.

FIG. 18 shows the internal configuration of the projector according to the third embodiment.

FIG. 19 is a perspective view showing the exterior appearance of the projector according to a fourth embodiment.

### DESCRIPTION OF EXEMPLARY EMBODIMENTS

### First Embodiment

A first embodiment of the present disclosure will be described below with reference to the drawings.

### Schematic Configuration of Projector

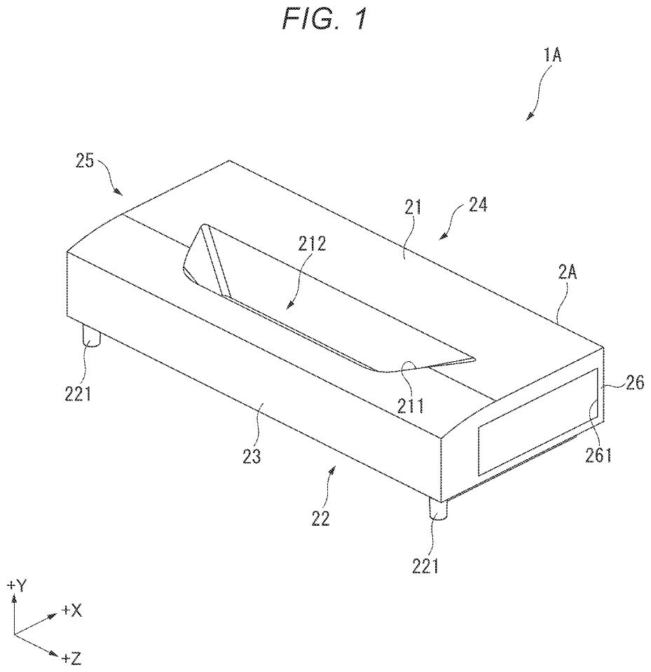

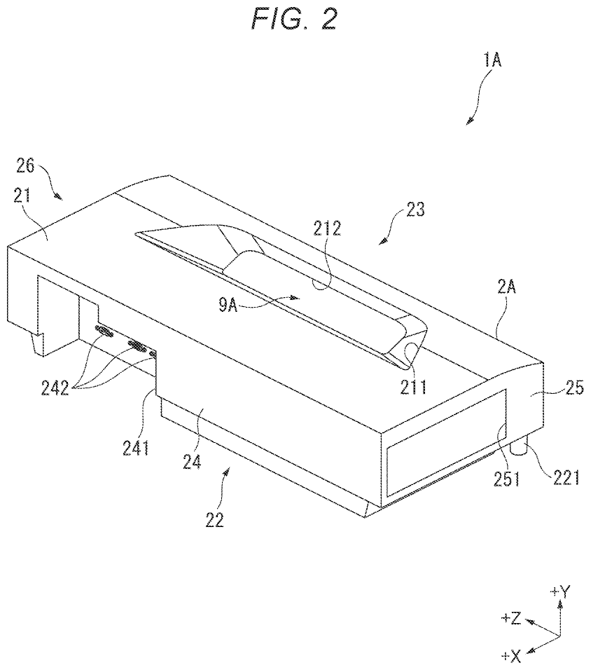

FIGS. 1 and 2 are perspective views showing the exterior appearance of a projector 1A according to the present embodiment. FIG. 1 is a perspective view of the projector 1A viewed from the front side, and FIG. 2 is a perspective view of the projector 1A viewed from the rear side.

The projector 1A according to the present embodiment is a projection apparatus that modulates the light outputted from a light source to generate an image according to image information and projects the generated image on a projection receiving surface, such as a screen. The projector 1A includes an exterior enclosure 2A, as shown in FIGS. 1 and 2.

### Configuration of Exterior Enclosure

The exterior enclosure 2A forms the exterior of the projector 1A and accommodates a controller 3, a power supply 4, a cooler 5A, an image projection apparatus 6, and other components that will be described later. The exterior enclosure 2A is formed in a substantially box-like shape and has a top surface 21, a bottom surface 22, a front surface 23, a rear surface 24, a left side surface 25, and a right side surface 26.

In the following description, three directions perpendicular to one another are called directions +X, +Y, and +Z. Although not shown, the direction opposite to the direction +X is a direction −X, the direction opposite to the direction +Y is a direction −Y, and the direction opposite to the direction +Z is a direction −Z.

The top surface 21 and bottom surface 22 are outer surfaces of the exterior enclosure 2A that intersect with the direction +Y.

The top surface 21 is disposed in a position shifted in the direction +Y from the bottom surface 22. The top surface 21 has a recess 211 recessed toward the bottom surface 22 and a passage port 212 provided at the bottom of the recess 211. An image projected from a projection optical apparatus 9A, which will be described later, passes through the passage port 211.

A plurality of legs 221, which are in contact with an installation surface where the projector 1A is installed, are provided at the bottom surface 22.

The front surface 23 and. rear surface 24 are outer surfaces of the exterior enclosure 2A that intersect with the direction +X.

The rear surface 24 is disposed in a position shifted in the direction +X from the front surface 23. The rear surface 24 has a recess 241 recessed toward the front surface 23 and a plurality of terminals 242 provided at the bottom of the recess 241, as shown in FIG. 2.

The left side surface 25 and the right side surface 26 are outer surfaces of the exterior enclosure 2A that intersect with the direction +Z.

The left side surface 25 has an opening 251. In the present embodiment, the opening 251 functions as a first discharge port via which a cooling gas having cooled cooling targets in the exterior enclosure 2A is discharged.

The right side surface 26 is disposed in a position shifted in the direction +Z from the left side surface 25. The right side surface 26 has an opening 261, as shown in FIG. 1. In the present embodiment, the opening 261 functions as a first introduction port via which gases outside the exterior enclosure 2A are introduced as the cooling gas into the exterior enclosure 2A.

### Internal Configuration of Projector

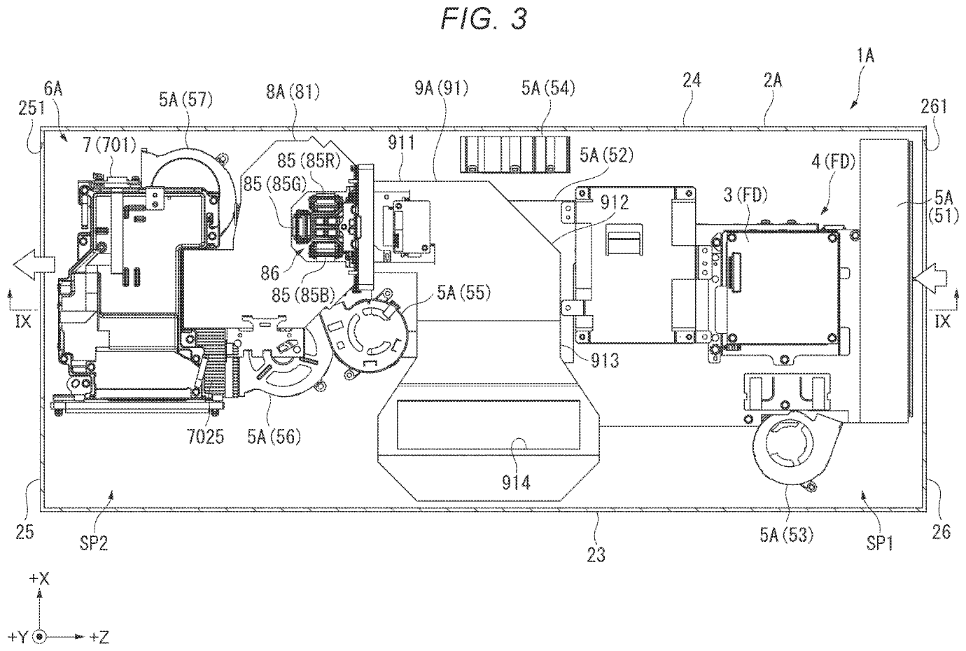

FIG. 3 shows the internal configuration of the projector 1A viewed in the direction +Y.

The projector 1A includes the controller 3, the power supply 4, the cooler 5A, and the image projection apparatus 6A, which are accommodated in the exterior enclosure 2A, as shown in FIG. 3.

The configuration of the cooler 5A will be described later in detail.

The controller 3 and the power supply 4 correspond to a first apparatus.

The controller 3 is a circuit substrate provided with a CPU (central processing unit) and other arithmetic processing circuits and controls the operation of the projector 1A.

The power supply 4 supplies electronic parts that form the projector 1A with electric power. The power supply 4 transforms externally supplied electric power and supplies the electronic parts with the transformed electric power. In the present embodiment, the power supply 4 is configured as a circuit substrate provided with a transformer and other circuit elements.

The controller 3 and the power supply 4 are provided in the exterior enclosure 2A and located in a space SP1 shifted in the direction +Z from the projection optical apparatus 9A located at the center of the exterior enclosure 2A. That is, the controller 3 and the power supply 4 are provided on the opposite side of the projection optical apparatus 9A from a light source apparatus 7 and an image generation apparatus 8A in the exterior enclosure 2A. The light source apparatus 7, the projection optical apparatus 9A, the controller 3, and the power supply 4, which will be described later, are therefore arranged in the direction +Z. In other words, the direction in which the light source apparatus the projection optical apparatus 9A, the controller 3, and the power supply 4 are arranged is the direction extending along the direction +Z.

The controller 3 and the power supply 4 are hereinafter referred to as a first apparatus FD for convenience of description.

### Configuration of Image Projection Apparatus

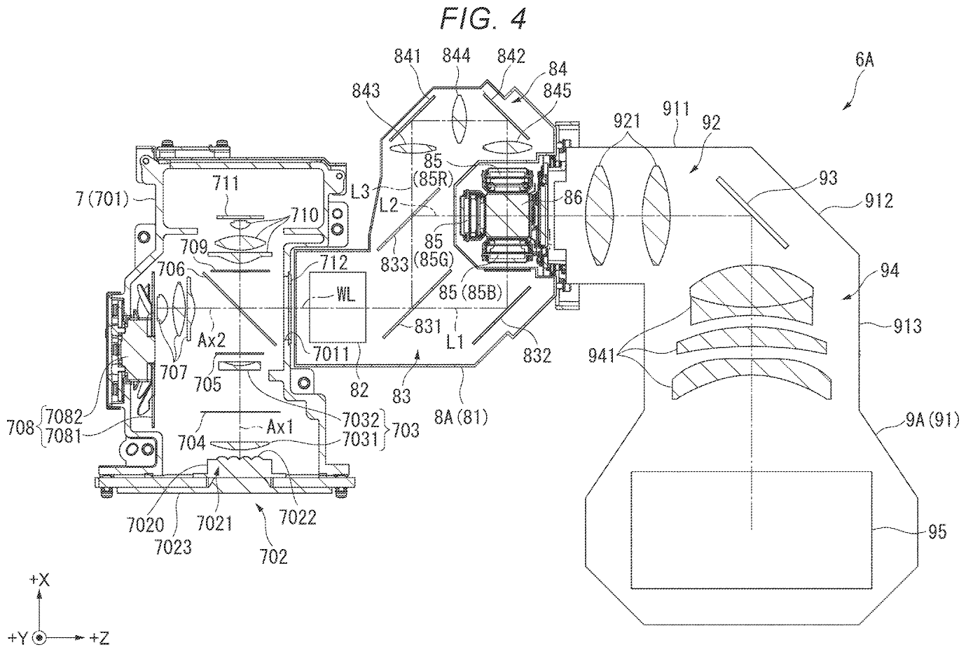

FIG. 4 is a diagrammatic view showing the configuration of the image projection apparatus 6A.

The image projection apparatus 6A generates an image according to an image signal inputted from the controller 3 and projects the generated image. The image projection apparatus 6A includes the light source apparatus 7, the image generation apparatus 8A, and the projection optical apparatus 9A, as shown in FIGS. 3 and 4.

The light source apparatus and the image generation apparatus 8A are provided in the exterior enclosure 2A and located in a space SP2 shifted in the direction −Z from the projection optical apparatus 9A located at the center of the exterior enclosure 2A.

### Configuration of Light Source Apparatus

The light source apparatus 7 outputs white light WL, which is illumination light, to the image generation apparatus 8A along the direction +Z. The light source apparatus 7 includes a light source enclosure 701 and the following components accommodated in the light source enclosure 701; a light source section 702; an afocal optical element 703; a first phase retarder 704; a diffusive transmission element 705; a light combiner 706; a first light collector 707; a wavelength conversion apparatus 708; a second phase retarder 709; a second light collector 710; a diffusive optical element 711; and a third phase retarder 712, as shown in FIG. 4.

The light source section 702, the afocal optical element 703, the first phase retarder 704, the diffusive transmission element 705, the light combiner 706, the second phase retarder 709, the second light collector 710, and the diffusive optical element 711 are arranged along an illumination optical axis Ax1 set in the light source apparatus 7. In the light source apparatus 7 of the image projection apparatus 6A, the illumination optical axis Ax1 is an illumination optical axis parallel to the direction +X.

The wavelength conversion apparatus 708, the first light collector 707, the light combiner 706, and the third phase retarder 712 are arranged along an illumination optical axis Ax2 set in the light source apparatus 7 and perpendicular to the illumination optical axis Ax1. In the light source apparatus 7 of the image projection apparatus 6A, the illumination optical axis Ax2 is an illumination optical axis parallel to the direction +Z.

### Configuration of Light Source Enclosure

The light source enclosure 701 is an enclosure that dust is unlikely to enter and is formed in a substantially box-like shape having a dimension in the direction +X greater than the dimension in the direction +Z. The light source enclosure 701 has an exit port 7011, via which the white light WL exits.

The light source apparatus 7 outputs the white light in the direction +Z along the light exiting optical axis of the exit port 7011. The light exiting optical axis of the exit port 7011 is the optical axis of the light that exits via the exit port 7011 and is also the light exiting optical axis of the light source apparatus 7. In the present embodiment, the light exiting optical axis of the light source apparatus 7 extends along the direction +Z.

### Configuration of Light Source Section

The light source section 702 outputs light in the direction +X. The light source section 702 includes a support member 7020, a plurality of solid-state light emitters 7021, which form a light source, and a plurality of collimator lenses 7022.

The support member 7020 supports the plurality of solid-state light emitters 7021 arranged in an array in a plane perpendicular to the illumination optical axis Ax1. The support member 7020 is a member made of metal, and heat of the plurality of solid-state light emitters 7021 is transferred to the support member 7020.

The plurality of solid-state light emitters 7021 each emit s-polarized blue light in the direction +X. The solid-state light emitters 7021 are each a semiconductor laser, and the blue light emitted by each of the solid-state light emitters 7021 is, for example, laser light having a peak wavelength of 440 nm.

The plurality of collimator lenses 7022 are provided in correspondence with the plurality of solid-state light emitters 7021. The plurality of collimator lenses 7022 convert the blue light emitted from the plurality of solid-state light emitters 7021 into parallelized light fluxes, which enter the afocal optical element 703.

The light source section 702 thus outputs linearly polarized blue light having a single polarization direction, but not necessarily. The light source section 702 may instead be configured to output s-polarized blue light and p-polarized blue light. In this case, the first phase retarder 704 can be omitted.

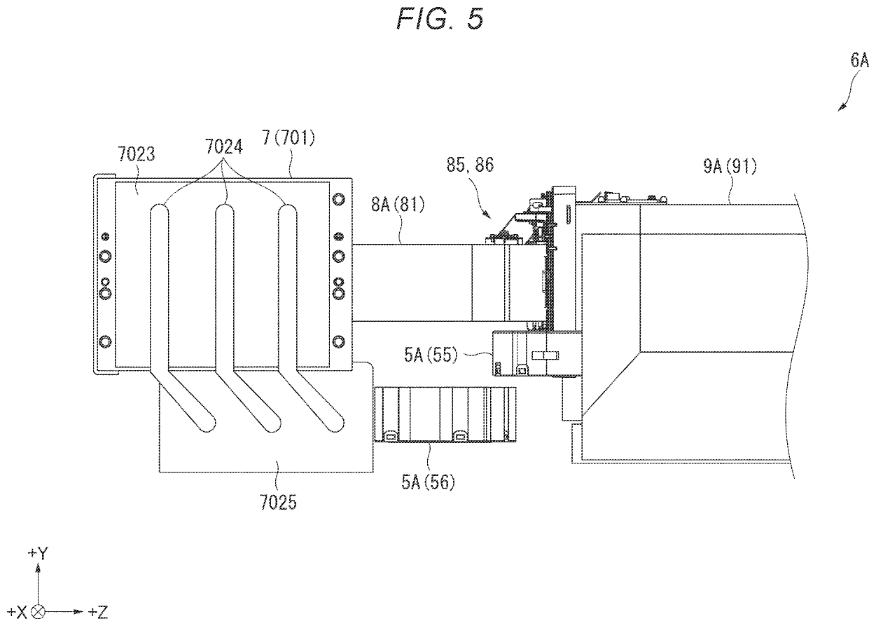

FIG. 5 is the light source section 702 viewed in the direction +X.

In addition to the configuration described above, the light source section 702 includes a heat receiving member 7023, heat pipes 7024, and a heat dissipating member 7025, as shown in FIG. 5.

The heat receiving member 7023 is provided on the opposite side of the plurality of solid-state light emitters 7021 from the light emitting side thereof, that is, in a position shifted in the direction −X from the plurality of solid-state light emitters 7021. The heat receiving member 7023 is coupled to the support member 7020 in a heat transferable manner and receives the heat of the plurality of solid-state light emitters 7021 transferred to the support member 7020.

The heat pipes 7024 couple the heat receiving member 7023 to the heat dissipating member 7025 in a heat transferable manner and transfer the heat transferred to the heat receiving member 7023 to the heat dissipating member 7025. The number of heat pipes 7024 is not limited to three and can be changed as appropriate.

The heat dissipating member 7025 is a heat sink with a plurality of fins. The heat dissipating member 7025 dissipates the heat transferred from the heat receiving member 7023 via the heat pipes 7024. The heat dissipating member 7025 is cooled by the cooling gas caused to flow by a fan 56, which forms the cooler 5A. The plurality of solid-state light emitters 7021 are thus cooled. In the present embodiment, the heat dissipating member 7025 is provided in a position shifted in the direction −Y from the light source enclosure 701. That is, the heat dissipating member 7025 is provided in a position shifted in the direction −Y from the solid-state light emitters 7021, which form the light source. The heat dissipating member 7025 may, however, instead be provided in a position shifted in the direction +Y from the light source enclosure 701.

### Configuration of Afocal Optical Element

The afocal optical element 703 shown in FIG. 4 reduces the diameter of the blue light flux incident from the light source section 702. The afocal optical element 703 is formed of a first lens 7031, which focuses the light incident thereon, and a second lens 7032, which parallelizes the light flux focused by the first lens 7031. The afocal optical element 703 may be omitted.

### Configuration of First Phase Retarder

The first phase retarder 704 is provided between the first lens 7031 and the second lens 7032. The first phase retarder 704 converts one type of linearly polarized light incident thereon into light containing s-polarized blue light and p-polarized blue light.

A pivot apparatus may cause the first phase retarder 704 to pivot around a pivotal axis extending along the illumination optical axis Ax1. In this case, the ratio between the s-polarized blue light and the p-polarized blue light in the light flux that exits out of the first phase retarder 704 can be adjusted in accordance with the angle of the pivotal movement of the first phase retarder 704.

### Configuration of Diffusive Transmission Element

The diffusive transmission element 705 homogenizes the illuminance distribution of the blue light incident from the second lens 7032. The diffusive transmission element 705 can, example, have a configuration including a hologram, a configuration in which a plurality of lenslets are arranged in a plane perpendicular to the optical axis, or a configuration is which a light passage surface is a rough surface.

The diffusive transmission element 705 may be replaced with a homogenizer optical element including a pair of multi-lenses.

### Configuration of Light Combiner

The blue light having passed through the diffusive transmission element 705 is incident on the light combiner 706.

The light combiner 706 outputs a first portion of the light emitted from the plurality of solid-state light emitters 7021 toward a wavelength converter 7081 and a second portion of the light toward the diffusive optical element 711. In detail, the light combiner 706 is a polarizing beam splitter that separates the s-polarized component and the p-polarized component contained in the light incident on the light combiner 706, reflects the s-polarized component, and transmits the p-polarized component. The light combiner 706 has color separation characteristics that cause the light combiner 706 to transmit light having a predetermined wavelength and longer wavelengths irrespective of the polarization state of the light incident on the light combiner 706, the s-polarized component or the p-polarized component. Therefore, out of the blue light incident from the diffusive transmission element 705, the s-polarized blue light is reflected off the light combiner 706 and enters the first light collector 707, and the p-polarized blue light passes through the light combiner 706 and enters the second phase retarder 709.

The light combiner 706 may instead have the function of a half-silvered mirror that transmits part of the light incident from the diffusive transmission element 705 and reflects the remaining light and the function of a dichroic mirror that reflects the blue light incident from the diffusive optical element 711 and transmits light incident from the wavelength conversion apparatus 708. In this case, the first phase retarder 704 and the second phase retarder 709 can be omitted.

### Configuration of First Light Collector

The first light collector 707 causes the blue light reflected off the light combiner 706 to be collected on the wavelength conversion apparatus 708. Further, the first light collector 707 parallelizes the light incident from the wavelength conversion apparatus 708. In the present embodiment, the first light collector 707 is formed of three lenses, but the number of lenses that form the first light collector 707 is not limited to a specific number.

### Configuration of Wavelength Conversion Apparatus

The wavelength conversion apparatus 708 converts the wavelength of the light incident thereon. The wavelength conversion apparatus 708 includes the wavelength converter 7081 and a rotator 7082.

Although not illustrated in detail, the wavelength converter 7081 is a phosphor wheel including a substrate and a phosphor layer provided at the light incident surface of the substrate. The phosphor layer contains phosphor particles. The phosphor particles are excited with the blue light, which is excitation light, and emit fluorescence having wavelengths longer than the wavelength of the incident blue light. The fluorescence is, for example, light having a peak wavelength ranging from 500 to 700 nm and contains green light and red light.

The rotator 7082 rotates the wavelength converter 7081 around an axis of rotation extending along the illumination optical axis Ax2. The rotator 7082 can be formed, for example, of a motor.

The thus configured wavelength conversion apparatus 708 outputs the fluorescence in the direction +Z along the optical axis of the wavelength converter 7081. The optical axis of the wavelength converter 7081 is perpendicular to the optical axis of the entire solid-state light emitters 7021, which extends along the direction +X, at the light combiner 706.

The fluorescence outputted from the wavelength converter 7081 passes through the first light collector 707 and the light combiner 706 along the illumination optical axis Ax2 and enters the third phase retarder 712.

### Configuration of Second Phase Retarder and Second Light Collector

The second phase retarder 709 is disposed between the light combiner 706 and the second light collector 710. The second phase retarder 709 converts the p-polarized blue light having passed through the light combiner 706 into circularly polarized blue light.

The second light collector 710 causes the blue light incident from the second phase retarder 709 to be collected on the diffusive optical element 711. Further, the second light collector 710 parallelizes the blue light incident from the diffusive optical element 711. The number of lenses that form the second light collector 710 can be changed as appropriate.

### Configuration of Diffusive Optical Element

The diffusive optical element 711 diffusively reflects the blue light incident thereon in the direction −X in such a way that the reflected blue light diffuses at an angle of diffusion equal to that of the fluorescence of from the wavelength converter 7081. The diffusive optical element 711 is a reflection member that reflects the blue light incident thereon in the Lambertian reflection scheme.

The optical axis of the diffusive optical element 711 extends along the direction −X. The optical axis of the diffusive optical element 711 coincides with the optical axis of the entire solid-state light emitters 7021 and is perpendicular to the optical axis of the wavelength converter 7081 at the light combiner 706. That is, the diffusive optical element 711 faces the solid-state light emitters 7021.

The diffusive optical element 711 is disposed in a position shifted in the direction +X from the light exiting optical axis of the light source apparatus 7. That is, the diffusive optical element 711 is disposed in a position shifted toward an entrance optical path 92 of the projection optical apparatus 9A from the light exiting optical axis of the light source apparatus 7.

The light source apparatus 7 may include a rotator that rotates the diffusive optical element 711 around an axis of rotation parallel to the illumination optical axis Ax1.

The blue light. reflected off the diffusive optical element 711 passes through the second light collector 710 along the direction −X and then enters the second phase retarder 709. When reflected off the diffusive optical element 711, the blue light is converted into circularly polarized light having a polarization. rotation direction opposite to the polarization rotation direction of the blue light before reflected. The blue light having entered the second phase retarder 709 via the second collector 710 is therefore converted into s-polarized blue light by the second phase retarder 709. The blue light incident on the light combiner 706 from the second phase retarder 709 is then reflected off the light combiner 706 and enters the third phase retarder 712. That is, the light that exits out of the light combiner 706 and enters the third phase retarder 712 is the white light WL, which is the mixture of the blue light and the fluorescence.

### Configuration of Third Phase Retarder

The third phase retarder 712 converts the white light. WL incident from the light combiner 706 into light that is the mixture of s-polarized light and p-polarized light. The white light WL having the thus converted polarization state as outputted from the light source apparatus 7 in the direction +Z along the light exiting optical axis of the light source apparatus 7 and enters the image generation apparatus 8A. That is, the extension of the light exiting optical axis of the light source apparatus coincides with the optical axis of the wavelength converter 7081 and intersects with the extension containing the optical axis of a passage optical path 94, which will be described later, in the projection optical apparatus 9A. In detail, the extension of the light exiting optical axis of the light source apparatus 7 intersects with the optical axis of the passage optical path 94. In the present specification, the extension containing the optical axis of the passage optical path 94 includes the optical axis of the passage optical path 94 and the extension of the optical axis of the passage optical path.

### Configuration of Image Generation Apparatus

The image generation apparatus 8A generates an image from the white light WL incident from the light source apparatus 7. In detail, the image generation apparatus 8A modulates the light incident from the light source apparatus to generate image light according to an image signal inputted from the controller 3.

The image generation apparatus 8A includes an enclosure 81, a homogenizer 82, a color separation apparatus 83, a relay apparatus 84, a light modulation apparatus 85, and a color combiner 86.

### Configurations of Enclosure and Homogenizer

The enclosure 81 accommodates the homogenizer 82, the color separation apparatus 83, and the relay apparatus 84. In the image generation apparatus 8A, an illumination optical axis that is an optical axis used at a design stage is set, and the enclosure 81 holds the homogenizer 82, the color separation apparatus 83, and the relay apparatus 84 along the illumination optical axis. The light modulation. apparatus 85 and the color combiner 86 are further disposed in the illumination optical axis.

The homogenizer 82 homogenizes the illuminance of the white light WL incident from the light source apparatus 7 and also aligns the polarization states of the white light WL with one another. The white light WL having illuminance homogenized by the homogenizer 82 travels via the color separation apparatus 83 and the relay apparatus 84 and illuminates a modulation region of the light modulation apparatus 85. Although not illustrated in detail, the homogenizer, 82 includes a pair of lens arrays that homogenize the illuminance, a polarization converter that aligns the polarization states with one another, and a superimposing lens that superimposes a plurality of sub-light fluxes into which the pair of lens arrays divide the white light WL with one another in the modulation region. The white light WL having passed through the homogenizer 82 is, for example, s-polarized linearly polarized light.

### Configuration of Color Separation Apparatus

The color separation apparatus 83 separates the white light WL incident from the homogenizer 82 into blue light L1, green light L2, and red light L3. The color separation apparatus 83 includes a first color separator 831, a first reflector 832, and a second color separator 833.

The first color separator 831 corresponds to a first reflective optical element and is disposed in a position shifted in the direction +Z from the homogenizer 82. The first color separator 831 transmits in the direction +Z the blue light L1 contained in the white light WL incident from the homogenizer 82 and reflects the green light L2 and the red light L3 contained in the white light. WL in the direction +X to separate the blue light L1 from the green light L2 and the red light L3. The blue light L1 separated by the first color separator 831 corresponds to first color light.

The first reflector 832 reflects in the direction +X the blue light L1 having passed through the first color separator 831 in the direction +Z. The blue light L1 reflected off the first reflector 832 enters a blue light modulator 85B. The optical axis of the blue light L1 between the first color separator 831 and the first reflector 832 coincides with the extension of the light exiting optical axis of the light source apparatus 7.

The second color separator 833 corresponds to a second reflective optical element and is disposed in a position shifted in the direction +X from the first color separator 831. The second color separator 833 reflects in the direction +Z the green light L2 reflected off the first color separator 831 and transmits the red light L3 in the direction +X to separate the green light L2 and the red light L3 from each other. The green light L2 separated by the second color separator 833 corresponds to second color light, and the red light L3 separated by the second color separator 833 corresponds to third color light.

The green light L2 separated by the second color separator 833 enters a green light modulator 85G. The red light L3 separated by the second color separator 833 enters the relay apparatus 84.

Configuration of Relay Apparatus

The relay apparatus 84 is provided in the optical path of the red light L3, which is longer than the optical paths of the blue light L1 and the green light L2, and suppresses loss of the red light L3. The relay apparatus 84 includes a second reflector 841, a third reflector 842, a light-incident-side lens 843, a relay lens 844, and a light-exiting-side lens 845.

The second. reflector 841 reflects in the direction +Z the red light L3 having passed through the second color separator 833 in the direction +X. The third reflector 842 reflects in the direction −X the red light L3 reflected off the second reflector 841. The light-incident-side lens 843 is disposed between the second color separator 833 and the second reflector 841. The relay lens 844 is disposed between the second reflector 841 and the third reflector 842. The light-exiting-side lens 845 is disposed between the second reflector 841 and a red light modulator 85R.

In the present embodiment, the relay apparatus 84 is provided in the optical path of the red light L3, but not necessarily. For example, the blue light L1 may be set as the color light having a longer optical path than the other color light, and the relay apparatus 84 may be provided in the optical path of the blue light L1.

Configuration of Light Modulation Apparatus

The light modulation apparatus 85 modulates the light incident thereon in accordance with an image signal. The light modulation apparatus 85 includes the blue light modulator 85B as a first light modulator, the green light modulator 85G as a second light modulator, and the red light modulator 85R as a third light modulator.

The blue light modulator 85B modulates the blue light L1 incident in the direction +X from the first reflector 832. The blue light L1 modulated by the blue light modulator 85B travels in the direction +X and enters the color combiner 86.

The green light modulator 85G modulates the green. light L2 incident in the direction +Z from the second color separator 833. The green light L2 modulated by the green light modulator 85G travels in the direction +Z and enters the color combiner 86.

The red light modulator 85R modulates the red light L3 incident in the direction −X via the light-exiting-side lens 845. The red light L3 modulated by the red light modulator 85R travels in the direction −X and enters the color combiner 86.

In the present embodiment, the light modulators 85B, 85G, and 85R each include a transmissive liquid crystal panel and a pair of polarizers that sandwich the transmissive liquid crystal panel.

### Configuration of Color Combiner

The color combiner 86 combines the blue light L1 modulated by the blue light modulator 85B, the green light L2 modulated by the green light modulator 85G, and the red light L3 modulated by the red light modulator 85R with one another to generate image light. Specifically, the color combiner 86 reflects in the direction +Z the blue light L1 incident in the direction +X from the blue light modulator 85B, transmits in the direction +Z the green light L2 incident in the direction +2 from the green light modulator 85G, and reflects in the direction +Z the red light L3 incident in the direction −X from the red light modulator 85R. The combined image light as the result of the combination performed by the light combiner 86 exits in the direction +Z along the light exiting optical axis of the light combiner 86, that is, the light exiting optical axis of the image generation apparatus 8A and enters the projection optical apparatus 9A. That is, the extension of the optical axis of the green light L2 reflected off the second color separator 833 coincides with the light exiting optical axis of the light combiner 86, and the light exiting optical axis of the light combiner 86 coincides with the light incident optical axis of the projection optical apparatus 9A.

In the present embodiment, the color combiner 86 is formed of a cross dichroic prism, but not necessarily. The color combiner 86 can be formed, for example, of a plurality of dichroic mirrors.

### Configuration of Projection Optical Apparatus

The projection optical apparatus 9A projects the image light generated by and incident from the image generation apparatus 8A onto the projection receiving surface described above. That is, the projection optical apparatus 9A projects the light modulated by the light modulation apparatus 85. The projection optical apparatus 9A is a projection lens including a lens enclosure 91, the entrance optical path 92, a deflection member 93, the passage optical path 94, and an optical path changing member 95.

The lens enclosure 91 corresponds to a projection optical apparatus enclosure. The lens enclosure 91 is configured to have an inverted L-letter-like shape when the lens enclosure 91 is so viewed in the direction +Y that the direction is oriented upward. The lens enclosure 91 includes an entrance section 911, a deflection section 912, and an exit section 913.

The entrance section 911 is a portion that extends in the direction +Z and forms the entrance optical path 92.

The deflection section 912 is a portion that couples the entrance section 911 to the exit section 913 and deflects in the direction −X the direction in which the image light travels along the entrance optical path 92 in the entrance section 911 in the direction +Z. The deflection member 93 is provided in the deflection section 912.

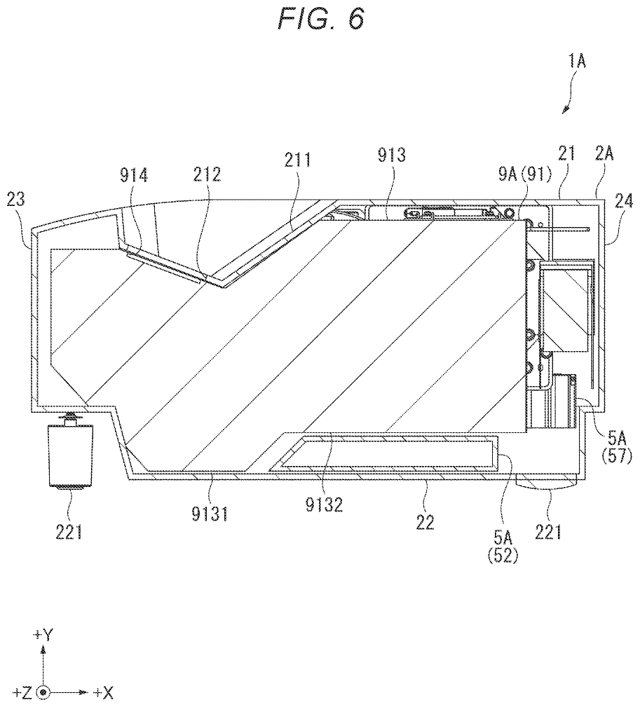

FIG. 6 shows a cross section of the projector 1A taken along a plane XY at the center in the direction +Z.

The exit section 913 is a portion that extends in the direction −X from the deflection section 912, forms the passage optical path 94, and accommodates the optical path changing member 95. That is, the exit section 913 is a portion of the lens enclosure 91 that is the portion according to the passage optical path 94. An opening 914 (see FIG. 3), via which the image light that travels in the direction converted by the optical path chancing member 95 passes, is provided in accordance with the optical path changing member 95 at a +Y-direction-side portion of the exit section 913.

The exit section. 913 includes a protrusion section. 9131, which is provided in a position shifted in the directions −X and −Y and protrudes in the direction −Y, and a recess 9132, which is provided in a position shifted in the directions +X and −Y and. recessed in the direction +Y, as shown in FIG. 6. In other words, the exit section 913 includes the protrusion 9131 as a first portion separate by a small distance from the bottom surface 22, which is a first outer surface of the exterior enclosure 2A, and the recess 9132 as a second portion separate by a large distance from the bottom surface 22. The space between the recess 9132 and the inner surface of the bottom surface 22 is a channel through which the cooling as can flow, and a part of a duct 52, which will be described later, of the cooler 5A is disposed in the recess 9132.

The entrance optical path 92 is an optical path which is provided in the entrance section 911 and along which the image light is incident in the direction +Z from the image generation apparatus 8A, as shown in FIG. 4. That is, the light incident optical axis of the projection optical apparatus 9A coincides with the optical axis of the entrance optical path 92 along the direction +Z. The light incident optical axis of the projection optical apparatus 9A is parallel to the light exiting optical axis of the light source apparatus 7 and is shifted in the direction +X from the exiting optical axis of the light source apparatus 7. A plurality of lenses 921 supported by the entrance section 911 are provided in the entrance optical oath 92.

The deflection member 93 deflects by 90° in the direction −X the direction of the image light having traveled along the entrance optical path 92 in the direction +Z. The deflection member 93 is formed, for example, of a reflection mirror.

The passage optical oath 94 is provided in the exit section 913 extending along the direction −X, and the image light from the deflection member 93 passes in the direction −X along the passage optical path 94. That is, the optical axis of the passage optical oath 94 extends along the direction −X. A plurality of lenses 941 supported by the exit section 913 are provided in the passage optical path 94.

The optical path changing member 95 is provided in the exit section 913 and located in a position shifted in the direction −X, which is the direction toward the light exiting side of the passage optical path 94. The optical path changing member 95 is an aspheric mirror that reverses the direction of the image light having traveled along the passage optical path 94. The image light reflected off the optical path changing member 95 passes through the opening 914 and diffuses while traveling in the direction +Y as the image light travels in the direction +X, which is the direction opposite to the direction in which the image light travels along the passage optical path. 94. A large-screen image can thus be displayed on the projection receiving surface even when the distance between the projector 1A and the projection receiving surface is short.

### Configuration of Cooler

The cooler 5A cools cooling targets that form the projector 1A. Specifically, the cooler 5A introduces gases outside the exterior enclosure 2A as the cooling gas into the exterior enclosure 2A and causes the introduced cooling gas to flow to the cooling targets to cool the cooling targets. The cooling targets cooled by the cooler 5A are, for example, the controller 3, the power supply 4, the light source apparatus 7, and the image generation apparatus 8A.

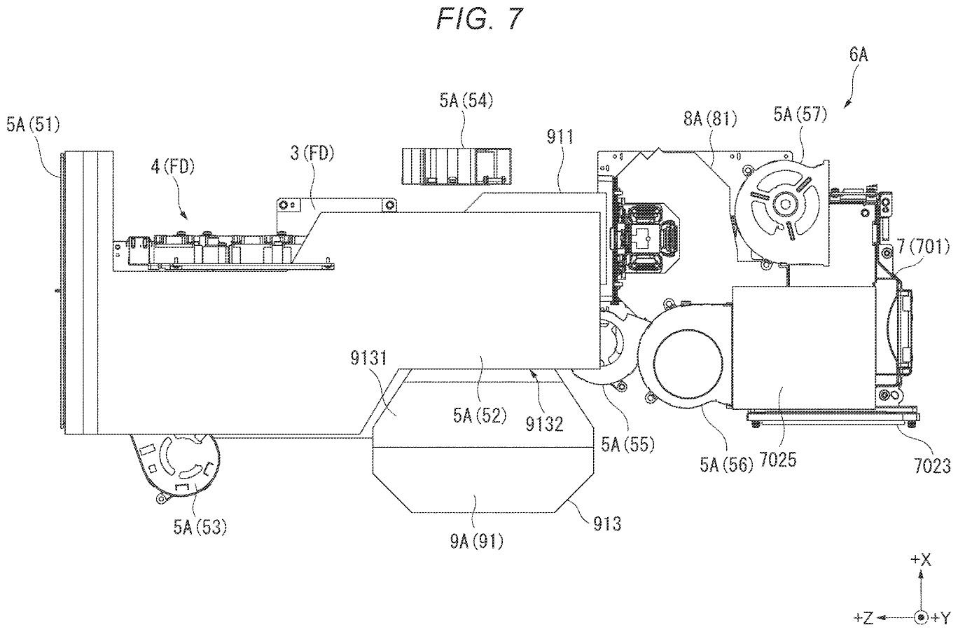

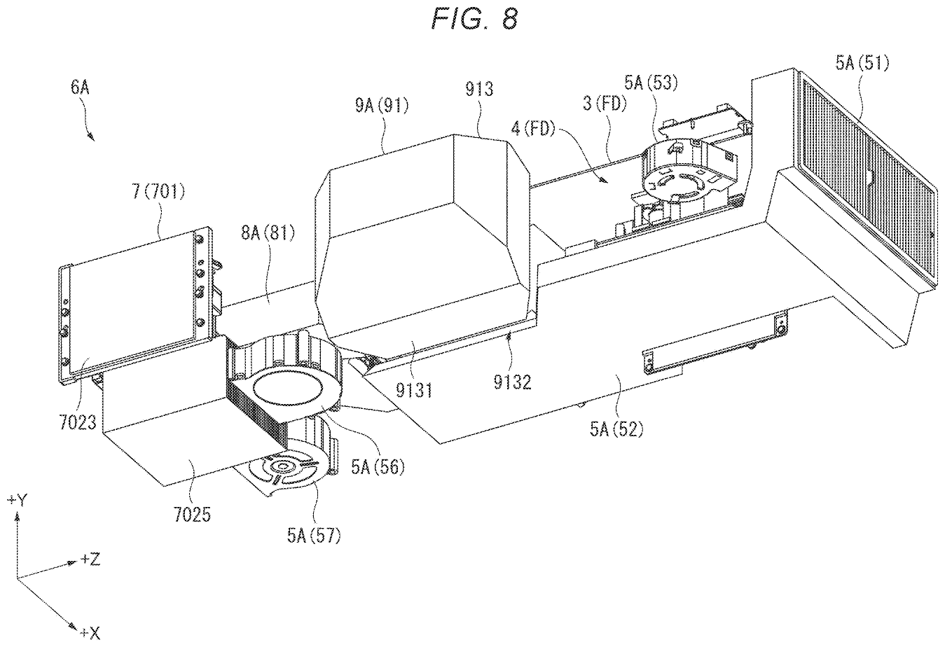

FIG. 7 shows the internal configuration of the projector 1A viewed in the direction −Y. FIG. 8 is a perspective view of the internal configuration of the projector 1A viewed in the directions −X and −Y.

The cooler 5A includes a filter 51, the duct 52, and fans 53 to 57, as shown in FIGS. 3, 7, and 8.

The filter 51 is provided at the opening 261, which functions as the first introduction port, in an attachable and detachable manner. The filter 51 removes dust contained in the air introduced as the cooling gas into the space SP1 in the exterior enclosure 2A via the opening 261. That is, the opening 261 is open into the space SP1.

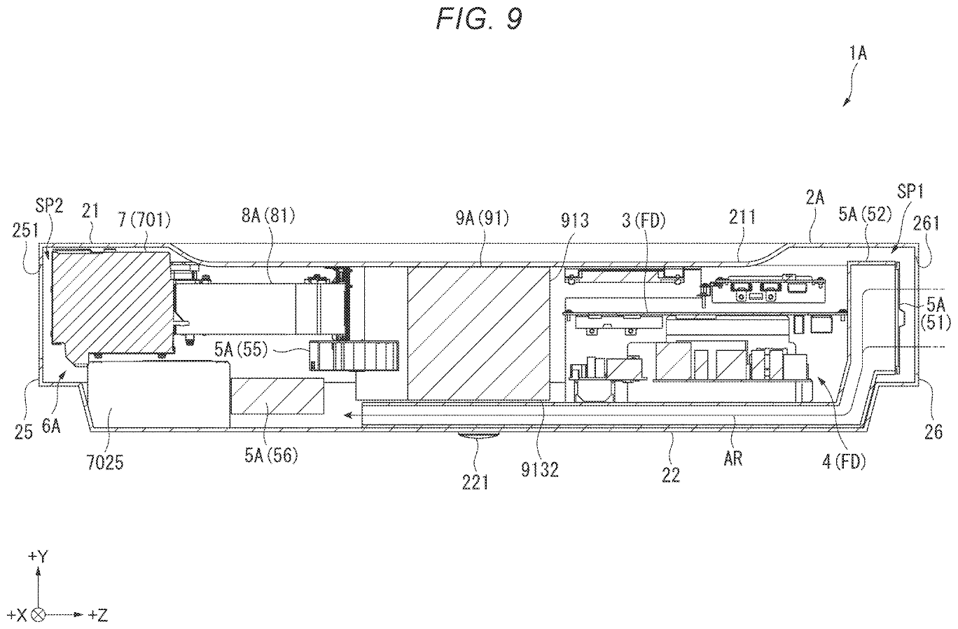

FIG. 9 shows a cross section of the projector 1A taken along a plane YZ. In detail, FIG. 9 shows the cross section taken along the line IX-IX in FIG. 3.

The duct 52 extends in the exterior enclosure 2A from a portion shifted in the direction +Z in the exterior enclosure 2A in the direction. −Z beyond the center of the exterior enclosure 2A in the direction +Z, as shown in FIGS. 3 and 7 to 9. One end of the duct 52 is coupled to the filter 51 provided in the opening 261, and the other end of the duct 52 is located in a position shifted in the direction −Z from the center of the exterior enclosure 2A in the direction +Z. The duct 52 thus causes the opening 261 to communicate with the space SP2 via the filter 51. In detail, key parts of the duct 52 are disposed in positions shifted in the direction −Y from the controller 3, the power supply 4, and the projection optical apparatus 9A, and part of the duct 52 located in the direction −Z is disposed in the recess 9132.

The duct 52 causes part of the cooling gas having passed through the filter 51 to flow in the direction −X to guide the cooling gas to the space SP2 located in a position shifted in the direction −Z from the projection optical apparatus 9A, as indicated by the arrow AR in FIG. 9. That is, the air introduced into the exterior enclosure 2A via the opening 261 through the filter 51 passes through the space between the bottom surface 22 as the first outer surface and the recess 9132 as the second portion. The key parts of the duct 52 may instead be disposed in positions shifted in the direction +Y from the controller 3, the power supply 4, and the projection optical apparatus 9A.

The fan 53 is disposed in the vicinity of the opening 261 in the exterior enclosure 2A, as shown in FIGS. 3, 7, and 8. The fan 53 sucks part of the cooling gas having passed through the filter 51 and sends the sucked cooling gas to the controller 3 and the power supply 4 in the space SP1 to cool the controller 3 and the power supply 4.

The fan 54 is disposed in the exterior enclosure 2A in a position substantially at the center in the direction +Z but shifted in the direction +X. The fan 54 sends in the direction −Z the cooling gas having cooled the controller 3 and the power supply 4. That is, the fan 54 causes the cooling gas introduced into the exterior enclosure 2A via the opening 261 to pass in the direction −Z through the space between the rear surface 24 and the entrance section 911, which is the portion corresponding to the entrance optical path 92 in the lens enclosure 91. The rear surface 24 is one of the outer surfaces of the exterior enclosure 2A, the outer surface located on the extension of the optical axis of the passage optical path 94.

The fans 55 and 56 cause the cooling gas to flow to the cooling targets in the space SP2, as shown in FIGS. 3 and 7 to 9. The fans 55 and 56 are disposed in the space surrounded by the image projection apparatus 6A in the exterior enclosure 2A. Specifically, the fans 55 and 56 are disposed in positions sandwiched between the light source apparatus and the exit section 913 of the projection optical apparatus 9 in the direction +Z and shifted in the direction −X from the image generation apparatus 8A. That is, the fans 55 and 56 are provided between the light source apparatus 7 and the passage optical oath 94 of the projection optical apparatus 9A in the direction +Z.

The fan 55 sucks part of the cooling gas introduced through the duct 52 into the space SP2 and sends the sucked cooling gas to the light modulation apparatus 85 85G, and 85R) to cool the light modulation apparatus 85.

The fan 55 sucks the other part of the cooling gas introduced through the duct 52 into the space SP2 and sends the sucked cooling gas to the heat dissipating member 7025 of the light scarce apparatus 7 to cool the heat dissipating member 7025.

The fan 57 is disposed in the vicinity of the opening 251 in the exterior enclosure 2A, as shown in FIGS. 3, 6, and 7. The fan 57 sucks the cooling gas having cooled the cooling targets and discharges the cooling gas out of the exterior enclosure 2A via the opening 251.

### Effects of First Embodiment

The projector 1A as the projection apparatus according to the present embodiment described above can provide the effects below.

The projector 1A includes the light source apparatus 7, the image generation apparatus 8A, and the projection optical apparatus 9A and further includes the controller 3 and the power supply 4, which form the first apparatus FD and are disposed on the opposite side of the projection optical apparatus 9A from the light source apparatus 7.

The promotion optical apparatus 9A has the entrance optical path 92, which the image light enters, and the passage optical path 94, which is the deflected extension of the entrance optical path 92. The image generation apparatus 8A causes the image light to enter the entrance optical path 92. The light source apparatus 7 supplies the image generation apparatus 8A with the illumination light.

The direction +X is a first direction extending along the optical axis of the passage optical path 94. The direction +Z is a second direction in which the light source apparatus 7, the projection optical device 9A, the controller 3, and the power supply 4 are arranged. The direction +Y is a third direction that intersects with each of the directions +X and +Z.

The configuration described above, in which the projection optical apparatus 9A has the entrance optical path 92 and the passage optical path 94, which is the deflected extension of the entrance optical path 92, allows reduction in the dimension of the projector 1A in the direction +X. Furthermore, since the light source apparatus 7 and the image generation apparatus 8A do not overlap with the controller 3 and the power supply 4 in the direction +Y, the dimension of the projector 1A in the direction +Y can be reduced. The projector 1A can therefore be made compact.

The projector 1A includes the exterior enclosure 2A, which forms the exterior of the projector 1A. The projection optical apparatus 9A includes the lens enclosure as the projection optical apparatus enclosure that accommodates the entrance optical path 92 and the passage optical path 94.

The exterior enclosure 2A has the opening 261 as the first introduction port provided at a portion facing the side where the first apparatus PD is disposed and the opening 251 as the first discharge port provided at a portion facing the side where the light source apparatus 7 is disposed. The cooling gas introduced into the exterior enclosure 2A via the opening 261 passes through the space between the exterior enclosure 2A and the exit section 913, which is the portion according to the passage optical path 94 in the lens enclosure 91.

The configuration described above allows the cooling gas introduced into the exterior enclosure 2A via the opening 261 to be discharged out of the exterior enclosure 2A via the opening 251 after the cooling gas is caused to flow via the controller 3, the power supply 4, and the light source apparatus 7. The controller 3, the power supply 4, and the light source apparatus 7 can thus be efficiently cooled.

The cooling gas introduced into the exterior enclosure 2A via the opening 261 passes through the space between the exit section 913 in the lens enclosure 91, which separates the space SP2 facing the light source apparatus 7 from the space SP1 facing the first apparatus FD, and the bottom surface 22 of the exterior enclosure 2A. The cooling gas can thus be readily caused to flow from space SP1 to space SP2. The cooling gas can therefore be readily caused. to flow in the exterior enclosure 2A, whereby the efficiency of the cooling of the controller 3, the power supply 4, and the light source apparatus 7 can be increased.

In the exterior enclosure 2A of the projector 1A, the opening 261 is provided at the right side surface 26 out of the right side surface 26 and the left side surface 25, which are the outer surfaces that intersect with the direction +Z, in which the light source apparatus 7, the projection optical apparatus 9A, and the first apparatus FD are arranged. The right side surface 26 is the outer surface facing the first apparatus FD, and the left side surface 25 is the outer surface facing the light source apparatus 7.

The configuration described above allows the air outside the exterior enclosure 2A to be readily introduced into the exterior enclosure 2A via the opening 261 as the first introduction port. The cooling gas can therefore be readily caused to flow to the controller 3, the power supply 4, and the light source apparatus 7 in the exterior enclosure 2A, whereby the efficiency of the cooling of the controller 3, the power supply 4, and the light source apparatus 7 can be increased.

The exterior enclosure 2A of the projector 1A has the bottom surface 22 as the first outer surface. The bottom surface 22 intersects with the direction +Y, which intersect with the direction −X extending along the passage optical path 94 and further intersects with the direction +Z, in which the light source apparatus 7, the projection optical apparatus 9A, and the first apparatus FD are arranged.

The lens enclosure 91 includes the following portions that form the exit section 913, which is the portion corresponding to the passage optical path 94: the protrusion 9131, which is a first portion separate by a small distance from the bottom surface 22; and the recess 9132, which is a second portion separate by a large distance from the bottom surface 22.

The cooling gas introduced into the exterior enclosure 2A via the opening 261 passes through the space between the bottom surface 22 and the recess 9132.

The configuration described above allows a channel along which the cooling gas flows in the direction −Z in the exterior enclosure 2A to be provided in the lens enclosure 91. The cooling gas is therefore allowed to smoothly flow in the direction −Z.

The fan 54 causes the cooling gas introduced into the exterior enclosure 2A via the opening 261, which functions as the first introduction port, to pass through the space between the rear surface 24 and the entrance section 911. The rear surface 24 is one of the outer surfaces of the exterior enclosure 2A, the outer surface located on the extension of the passage optical path 94. The entrance section 911 is the portion corresponding to the entrance optical path 92 in the lens enclosure 91.

The configuration described above allows a channel along which the cooling gas flows in the direction −Z in the exterior enclosure 2A to be provided between the rear surface 24, which is the outer surface located on the extension of the optical axis of the passage optical path 94, and the lens enclosure 91. The cooling gas is therefore allowed to smoothly flow in the direction −Z.

The projector 1A includes the fans 55 and 56 provided between the passage optical path. 94 and the light source apparatus 7.

In the projector 1A, the image projection apparatus 6A is configured to have an inverted L-letter-like shape, when the image projection apparatus 6A is so viewed in the direction +Y that the direction +X is oriented upward. The space between the passage optical path 94 and the light source apparatus 7 is therefore likely to form a dead space.

In the situation described above, the fans 54 and 55 can be disposed in the region that is likely to form a dead space. The parts that form the projector 1A can therefore be disposed therein in a packed manner, whereby the dimensions of the projector 1A can be reduced, so that the projector 1A can be made compact.

In the projector 1A, the light source apparatus 7 includes the solid-state light emitters 7021, which form the light source, and the heat dissipating member 7025, to which the heat of the solid-state light emitters 7021 is transferred. The heat dissipating member 7025 is provided in a position shifted from the light source enclosure 701 in the direction −Y, which is perpendicular to the direction. +Z, in which the light source apparatus 7, the projection. optical apparatus 9A, and the first apparatus FD are arranged, and the direction −X, which is the direction extending along the passage optical path 94.

According to the configuration described above, the heat dissipating member 7025 can increase the heat dissipation area via which the heat of the solid-state light emitters 7021 is dissipated. The heat dissipation efficiency in accordance with which the heat generated by the solid-state light emitters 7021 is dissipated can therefore be further increased. Further, the projector 1A can be made compact in the direction +X as compared with a case where the heat dissipating member 7025 is provided in a position shifted in the direction +X or −X from the solid-state light emitters 7021.

### First Variation of First Embodiment

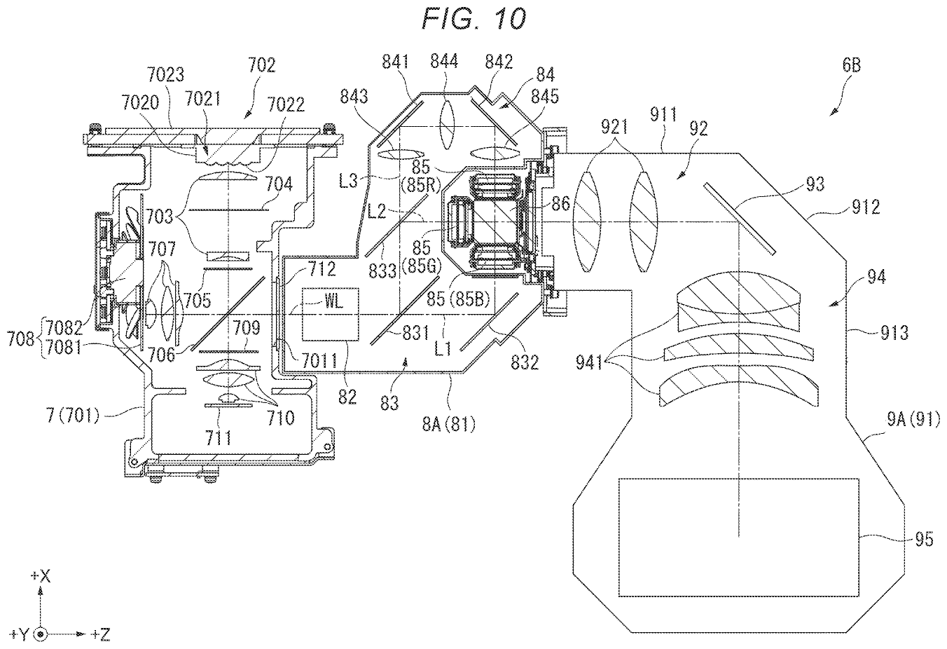

FIG. 10 is a diagrammatic view showing the configuration of an image projection apparatus 6B, which is a first variation of the image projection apparatus 6A.

In the image projection apparatus 6A, the light source section 702, which forms the light source apparatus outputs light in the direction +X, and the diffusive optical element 711 reflects the blue light in the direction −X. However, the light source section 702 may be disposed so as to output the light in the direction −X, and the diffusive optical element 711 may be disposed so as to reflect the blue light in the direction +X. That is, the projector 1A may employ the image projection apparatus 6B shown in FIG. 10 in place of the image projection apparatus 6A.

The image projection apparatus 6B includes the light source apparatus 7, the image generation apparatus 8A, and the projection optical apparatus 9A, as the image projection apparatus 6A does. When the projector 1A employs the image projection apparatus 6B, the projection optical apparatus 9A is disposed substantially at the center of the exterior enclosure 2A in the direction +Z, and the light source apparatus 7 and the image generation apparatus 8A are disposed in the space SP2 shifted in the direction −Z from the projection optical apparatus 9A.

In the image projection apparatus 6B, the light source apparatus 7 is disposed in the state in which the light source apparatus 7 pivots by 180° around the light exiting optical axis thereof.

Therefore, in the image projection apparatus 6A and the image projection apparatus 6B, the wavelength conversion apparatus 708 outputs the fluorescence in the same direction, and the white light WL exits via the exit port 7011 in the same direction.

However, in the image projection apparatus 6A and the image projection apparatus 6B, the light source section 702 outputs the blue light in opposite directions, and the diffusive optical element 711 reflects the blue light in opposite directions. That is, in the image projection apparatus 6B, the plurality of solid-state light emitters 7021 are disposed as a whole in a position shifted in the direction +X, which is the direction toward the entrance optical path 92, from the light exiting optical axis of the light source apparatus 7, and the diffusive optical element 711 is disposed in a position shifted in the direction −X from the light exiting optical axis of the light source apparatus 7. In the image projection apparatus 6B, the plurality of solid-state light emitters 7021 emit the blue light in the direction −X, and the diffusive optical element 711 reflects the blue light in the direction +X.

The light source apparatus 7 of the image projection apparatus 6B also outputs the white light WL which is the illumination light, in the direction +Z, as the light source apparatus 7 of the image projection apparatus 6A does, and the outputted white light WL enters the image generation apparatus 8A. That is, the light source apparatus 7 supplies the image generation apparatus 8A with the illumination light,

The projector 1A including the thus configured image projection apparatus 6B can provide the same effects as those provided by the projector 1A including the image projection apparatus 6A and can further enlarge the space shifted in the direction −X from the light source apparatus 7 in the exterior enclosure 2A. The flexibility of the layout of the fans and other components in the exterior enclosure 2A can therefore be increased.

### Second Variation of First Embodiment

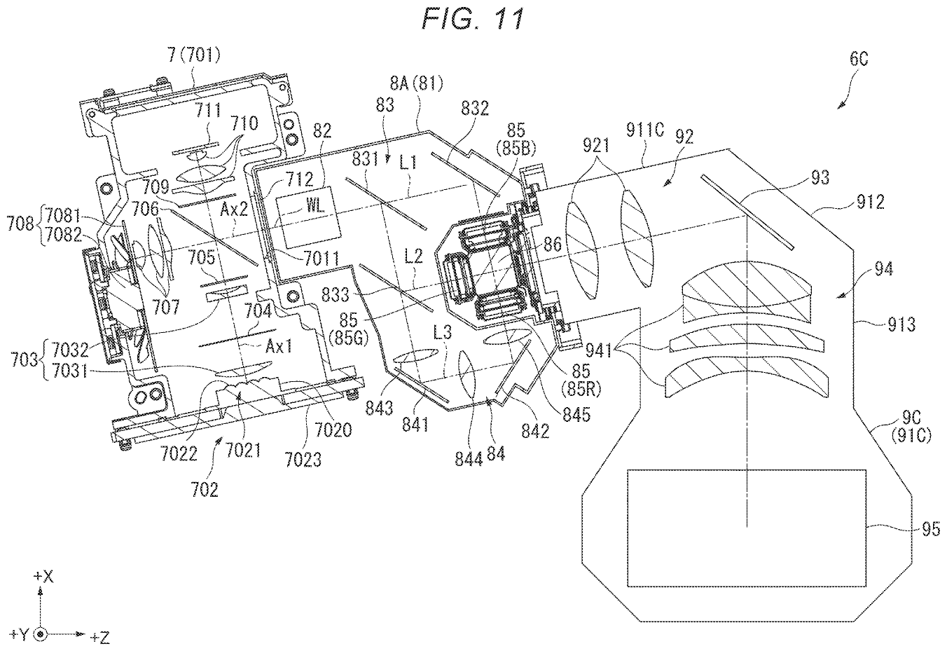

FIG. 11 is a diagrammatic view showing the configuration of an image projection apparatus 6C, which is a second variation of the image projection apparatus 6A.

In the image projection apparatus 6A, the light exiting optical axis of the light source apparatus 7 and the light incident optical axis of the projection optical apparatus are parallel the direction +Z, but not necessarily. The light exiting optical axis of the light source apparatus 7 and the light incident optical axis of the projection optical apparatus 9A may incline with the direction +Z. That is, the projector 1A may employ the image projection apparatus 6C shown in FIG. 11 in place of The image projection apparatus 6A.

The image projection apparatus 6C has the same configuration and function as those of the image projection apparatus 6A except that the projection optical apparatus 9A is replaced with a projection optical apparatus 9C. That is, the image projection apparatus 6C includes the light source apparatus 7, the image generation apparatus 8A, and the projection optical apparatus 9C. When the projector 1A employs the image projection apparatus 6C, the projection optical apparatus 9C is disposed substantially at the center of the exterior enclosure 2A in the direction +Z, and the light source apparatus 7 and the image generation apparatus 8A are disposed in the space SP2 shifted in the direction −Z from the projection optical apparatus 9C.

The projection optical apparatus 9C has the same configuration and function as those of the projection optical apparatus 9A except that the lens enclosure 91 is replaced with a lens enclosure 91C. That is, the projection optical apparatus 9C includes the lens enclosure 910, the entrance optical path 92, the deflection member 93, the passage optical path 94, and the optical path changing member 95.

The lens enclosure 91C corresponds to the projection optical apparatus enclosure and is configured to have an inverted. L-letter-like shape when the lens enclosure 91C is so viewed in the direction +Y that the direction +X is oriented upward. The lens enclosure 91C includes the entrance section 911, the deflection section 912, and the exit section 913.

The entrance section 911C forms the entrance optical path 92, which the image light enters. The entrance section 911C is disposed so as to incline with respect to the direction +Z, so that the optical axis of the entrance optical path 92 also inclines with respect to the direction +Z. The optical axis of the entrance optical path 92 intersects at the deflection member 93 with the passage optical path 94, which is parallel to the direction −X, at an angle other than 90°. In detail, the angle of intersection of the optical axis of the entrance optical path 92 and the optical axis of the passage optical path 94 is an acute angle, for example, about 77.5°.

Also in the lens enclosure 91C, the exit section 913 is disposed along the direction −X, so that the optical axis of the passage optical path 94 provided in the exit section 913 extends along the direction −X.

In the image projection apparatus 6C, the light. source apparatus 7 is so disposed that the light exiting optical axis of the light source apparatus 7 is parallel to the optical axis of the entrance optical path 92, and the image generation apparatus 8A is so disposed that the optical axis of the image light outputted from the image generation apparatus 8A coincides with the optical axis or the entrance optical path 92.

In the light source apparatus 7 of the image projection apparatus 6C, the solid-state light emitters 7021 are disposed as a whole in a position shifted in the direction −X from the diffusive optical element 711, as in the light source apparatus 7 of the image projection apparatus 6A. The solid-state light emitters 7021 and the diffusive optical element 711 are so disposed that the optical axis of the entire solid-state light emitters coincides with the optical axis of the diffusive optical element 711 and the solid-state light emitters 7021 face the diffusive optical element 711. The optical axis of the wavelength converter element 7081 intersects with the optical axis of the entire solid-state light emitters 7021 and the optical axis of the diffusive optical element 711 at the light combiner 706 and coincides with the light exiting optical axis of the light source apparatus 7.

On the other hand, the light exiting optical axis of the light source apparatus 7 does not intersect with the optical axis of the passage optical path 94 but intersects with part of the extension of the optical axis of the passage optical path 94, the extension extending in the direction +X from the deflection member 93.

In the image generation apparatus 8A of the image projection apparatus 6C, the first color separator 831 transmits the blue light L1 contained in the white light WI incident from the homogenizer 82 and reflects the green light L2 and the red light L3 contained in the white light WL in the direction −X, which is the direction perpendicular to the extension of the optical axis of the light exiting optical axis of the light source apparatus 7.

The first reflector element 832 reflects the blue light L1 incident from the first color separator 831 to cause the reflected blue light L1 to enter the blue light modulator 85B disposed in a position shifted in the direction +X from the color combiner 86.

The second color separator 833 reflects the green light L2 incident from the first color separator 831 to cause the reflected green light L2 to enter the green light modulator 85G disposed in a position shifted in the direction −Z from the color combiner 86. The second color separator 833 transmits the red light L3 incident from the first color separator 831 to cause the transmitted red light L3 to enter the relay apparatus 84.

The relay apparatus 84 causes the red light L3 incident from the second color separator 833 to enter the red light modulator 85R disposed in a position shifted in the direction −X from the color combiner 86.

The color combiner 86 outputs to the entrance optical path 92 the image light that is the combination of the color light L1 incident from the light modulator 85B, the color light. L2 incident from the light modulator 85G, and the color light L3 incident from the light modulator 85R.

The projector 1A including the thus configured image projection apparatus 6C can provide the same effects as those provided by the projector 1A including the image projection apparatus 6A.

The angle of intersection of the optical axis of the entrance optical path 92 and the optical axis of the passage optical path 94 may instead be an obtuse angle. That is, the deflection member 93 may deflect the direction of the image light having traveled along the entrance optical path 92 at an obtuse angle. The angle of intersection of the optical axis of the entrance optical path 92 and the optical axis of the passage optical path 94 is not limited to about 77.5° when the angle of intersection is an acute angle.

### Third Variation of First Embodiment

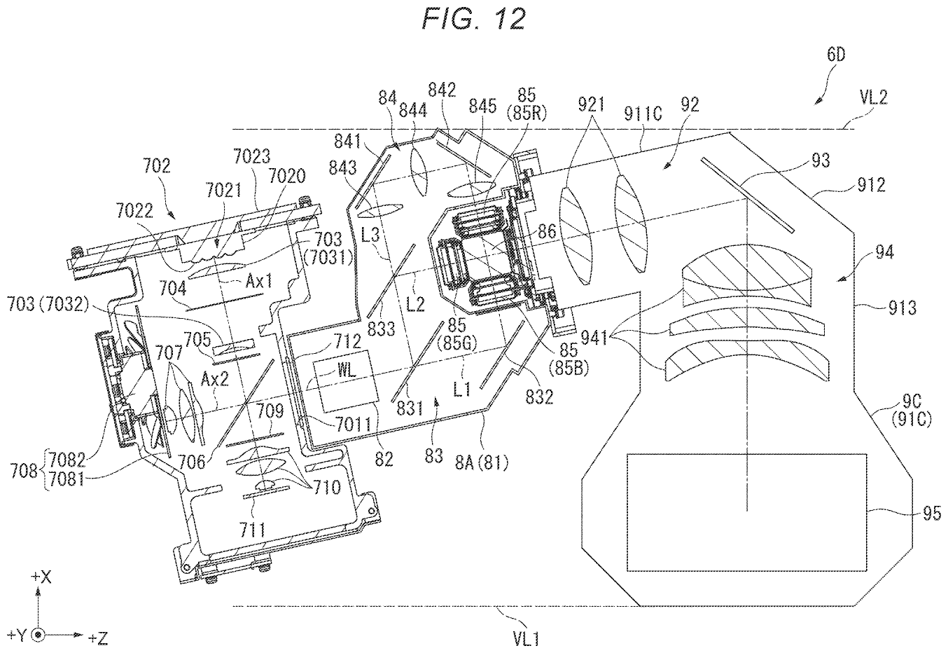

FIG. 12 is a diagrammatic view showing the configuration of an image projection apparatus 6D, which is a variation of the image projection apparatus 6C. That is, FIG. 12 is a diagrammatic view showing the configuration of the image projection apparatus 6D, which is a third variation of the image projection apparatus 6A.

In the image projection apparatus 6C, the light source section 702, which form the light source apparatus 7, is disposed in a position shifted in the direction −X from the diffusive optical element 711. The light source section 702 may, however, be disposed in a position shifted in the direction +X from the diffusive optical element 711. That is, the projector 1A may employ the image projection apparatus 6D shown in FIG. 12 in place of the image projection apparatus 6C.

The image projection apparatus 6D includes the light source apparatus 7, the image generation apparatus 8A, and the projection optical apparatus 9C, as the image projection apparatus 6C does. When the projector 1A employs the image projection apparatus 6D, the projection optical apparatus 9C is disposed substantially at the center of the exterior enclosure 2A in the direction +Z, and the light source apparatus 7 and the image generation apparatus 8A are disposed in the space SP2 shifted in the direction −Z from the projection optical apparatus 9C.

The light source apparatus of the image projection apparatus 6D is disposed in the state in which the light source apparatus 7 pivots by 180° around the light exiting optical axis thereof as compared with the light source apparatus 7 of the image projection apparatus 6C.

Therefore, in the image projection apparatus 6C and the image projection apparatus 6D, the wavelength conversion apparatus 708 outputs the fluorescence in the same direction, and the white light WL exits via the exit port 7011 in the same direction.

However, in the image projection apparatus 61 and the image projection apparatus 6D, the light source section 702 outputs the blue light in opposite directions, and the diffusive optical element 711 reflects the blue light in opposite directions. That is, in the image projection apparatus 6D, the plurality of solid-state light, emitters 7021 are disposed as a whole in a position shifted in the direction +X from the diffusive optical element 711.

The light source apparatus 7 of the image projection apparatus 6D also outputs the white light WL, which is the illumination light, in the direction +Z, along the light exiting optical axis of the light source apparatus 7, which is parallel to the optical axis of the entrance optical path 92, as the light source apparatus 7 of the image projection apparatus 61 does, and the outputted white light WL enters the image generation apparatus 8A. That is, the light source, apparatus 7 supplies the image generation apparatus 8A with the illumination light.

In the image projection apparatus 6D, the light source apparatus 7 is so disposed that the light exiting optical axis of the light source apparatus 7 is parallel to the optical axis of the entrance optical path 92. The light exiting optical axis of the light source apparatus 7 is shifted in the direction −X from the optical axis of the entrance optical path 92 and intersects the optical axis of the passage optical path 94.

In the image generation apparatus 8A of the image projection apparatus 6D, the first color separator 831 transmits the blue light L1 contained in the white light WI incident from the homogenizer 82 and reflects the green. light L2 and the red light L3 contained in the white light WL in the direction +X, which is the direction perpendicular to the extension of the light exiting optical axis of the light source apparatus 7.

The first reflector 832 reflects the blue light L1 incident from the first color separator 831 to cause the reflected blue light L1 to enter the blue light modulator 85B disposed in a position shifted in the direction +X from the color combiner 86.

The second color separator 833 reflects the green light L2 incident from the first color separator 831 to cause the reflected green light L2 to enter the green light modulator 85G disposed in a position shifted in the direction −Z from the color combiner 86. The second color separator 833 transmits the red light L3 incident from the first color separator 831 to cause the transmitted red light L3 to enter the relay apparatus 84.

The relay apparatus 84 causes the red light L3 incident from the second color separator 833 to enter the red light modulator 85R disposed in a position shifted in the direction +X from the color combiner 86.

The color combiner 86 outputs to the entrance optical path 92 the image light that is the combination of the color light L1 incident from the light modulator 85B, the color light L2 incident from the light modulator 85G, and the color light L3 incident from the light modulator 85R.

The projector 1A including the thus configured image projection apparatus 6D can provide the same effects as those provided by the projector 1A including the image projection apparatus 6C.

In addition to the above, the light exiting optical axis of the light source apparatus 7 of the image projection apparatus 6D intersects with the optical axis of the passage optical path 94. The configuration described above can suppress protrusion of the light source apparatus 7 in the direction −X beyond an imaginary line VL1, which extends along the direction +Z, which is perpendicular to the direction −X, and passes through an end of the projection optical apparatus 9C that is the end shifted in the direction −X, which extends along the optical axis of the passage optical path 94, when viewed in the direction +Y. For example, the configuration described above prevents the diffusive optical element 711 located in a position closest to the negative side of the direction X, out of the solid-state light emitters 7021, the wavelength converter 7081, and the diffusive optical element 711, from being disposed in a position shifted in the direction −X from the imaginary line VL1 when viewed in the direction +Y.

The configuration can further suppress protrusion. of the light source apparatus 7 in the direction. +X beyond an imaginary line VL2, which extends along the direction +Z, which is perpendicular to the direction +X, and passes through an end of the projection optical apparatus 9C that is the end shifted in the direction +X extending along the optical axis of the passage optical path 94, when viewed in the direction +Y. For example, the configuration described above prevents the solid-state light emitters 7021 located in a position closest to the positive side of the direction X, out of the solid-state light emitters 7021, the wavelength converter 7081, and the diffusive optical element 711, from being disposed in a position shifted in the direction +X from the imaginary line VL2 when viewed in the direction +Y.

The image projection apparatus 6D and in turn the projector 1A can therefore be made compact in the direction +X as compared with at least one of a case where the light source apparatus 7 protrudes in the direction −X beyond the virtual line VL1 and a case where the light source apparatus 7 protrudes in the direction +X beyond the virtual line VL2.

### Fourth Variation of First Embodiment

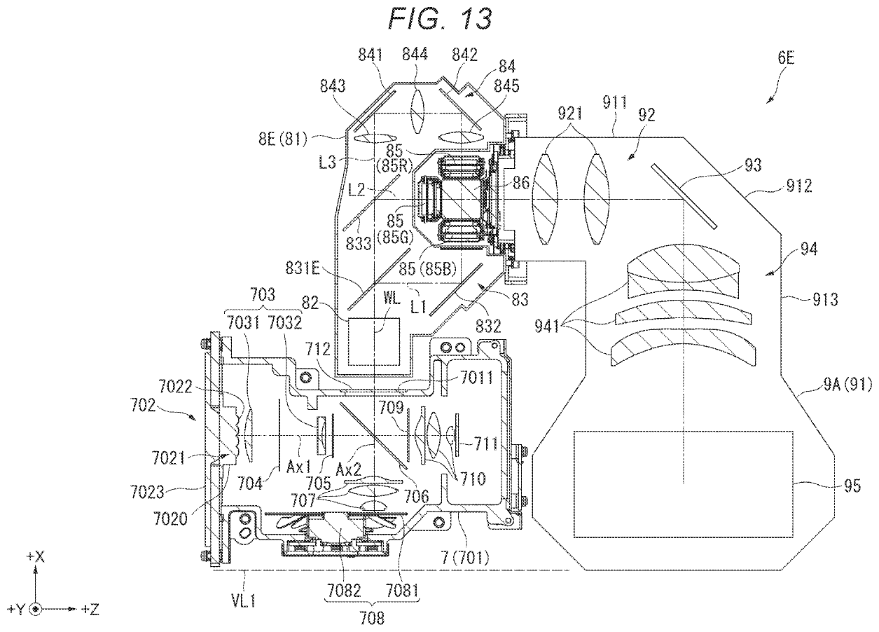

FIG. 13 is a diagrammatic view showing the configuration of an image projection apparatus 6E, which is a fourth variation of the image projection apparatus 6A.

In the image projection apparatus 6A, the light exiting optical axis of the light source apparatus 7 is parallel to the direction +Z. The light exiting optical axis of the light source apparatus 7 may, however, be parallel to the direction +X. For example, the projector 1A may employ the image projection apparatus 6E shown in FIG. 13 in place of the image projection apparatus 6A.

The image projection apparatus 6E has the same configuration and function as those of the image projection. apparatus 6A except that the image generation apparatus 8A is replaced with an image generation apparatus 81 and the light source apparatus 7 is disposed differently. When the projector 1A employs the image projection apparatus 6E, the projection optical apparatus 9A is disposed substantially at the center of the exterior enclosure 2A in the direction +Z, and the light source apparatus 7 and the image generation apparatus 81 are disposed in the space SP2 shifted in the direction −Z from the projection optical apparatus 9A.

In the image projection apparatus 61, the light source apparatus 7 is so disposed that the light exiting optical axis of the light source apparatus 7 is parallel to the direction +X and the white light WL, which is the illumination light, exits in the direction +X. The light exiting optical axis of the light source apparatus 7 is therefore not parallel to the optical axis of the entrance optical path 92 in detail, in the image projection apparatus 61, the light exiting optical axis of the light source apparatus 7 is perpendicular to the optical axis of the entrance optical path 92, which is parallel to the direction +Z, and parallel to the optical axis of the passage optical path 94.

In the image projection apparatus 61, the solid-state light emitters 7021 and the diffusive optical element 711 are so disposed that the optical axis of the entire solid-state light emitters 7021 coincides with the optical axis of the diffusive optical element 711 and that the optical axis of the solid-state light emitters 7021 and the optical axis of the diffusive optical element 711 are parallel in the direction +Z. That is, the solid-state light emitters 7021 faces the diffusive optical element 711 in the direction +Z.

The wavelength converter 7081 is so disposed that the optical axis of the wavelength converter 7081 coincides with the extension of the light exiting optical axis of the light source apparatus 7 and that the wavelength converter 7081 outputs the fluorescence in the direction +X. The optical axis of the entire solid-state light emitters 7021 and the optical axis of the diffusive optical element 711 intersect with the optical axis of the wavelength converter 7081 at the light combiner 706. The extension of the optical axis of the entire solid-state light emitters 7021 is perpendicular to the optical axis of the passage optical path 94. The aforementioned arrangement of the light source apparatus 7 suppresses protrusion of the light source apparatus 7 in the direction −X beyond the virtual line VL1 described above.

In the image projection apparatus 6E shown in FIG. 13, the solid-state light emitters 7021 are provided as a whole in a position shifted in the direction −Z from the diffusive optical element 711 in the light source apparatus 7, but not necessarily. The solid-state light emitters 7021 may instead be provided as a whole in a position shifted in the direction +Z from the diffusive optical element 711.

The image generation apparatus 8E has the same configuration and function as those of the image generation apparatus 8A except that the first color separator 831 is replaced with a first color separator 831E and the homogenizer 82 is disposed differently.

In the image generation apparatus 8E, the homogenizer 82 is disposed in the light exiting optical axis, which extends along the direction +X, of the light source apparatus 7.

The first color separator 831E corresponds to the first reflective optical element. The first color separator 831E reflects in the direction +Z the blue light L1 contained in the white light WL incident in the direction +X from the light apparatus 7 via the homogenizer 82 and transmits the green light L2 and the red light L3 contained in the white light WL in the direction +X.

Out of the blue light L1, the green light L2, and the red light L3 separated by the first color separator 831E, the blue light L1 is guided by the first reflector 832 to the blue light modulator 8513, as in the image generation apparatus SA. The green light L2 is guided by the second color separator 833 to the green light modulator 85G. The red light L3 is guided by the second color separator 833 and the relay apparatus 84 to the red light modulator 85R.

The blue light L1, the green light L2, and the red light L3 modulated by the light modulators 85B, 85G, and 85R are combined with one another by the color combiner 86. The image light that is the combined light as the result of the combination performed by the color combiner 66 exits in the direction +Z along the light exiting optical axis of the image generation apparatus 8E.

The image light having entered the entrance optical path 92 from the image generation apparatus 8E is projected by the projection optical apparatus 9A onto the projection receiving surface.

The projector 1A including the thus configured image projection apparatus 6E can provide the same effects as those provided by the projector 1A including the image projection apparatus 6A.

### Fifth Variation of First Embodiment

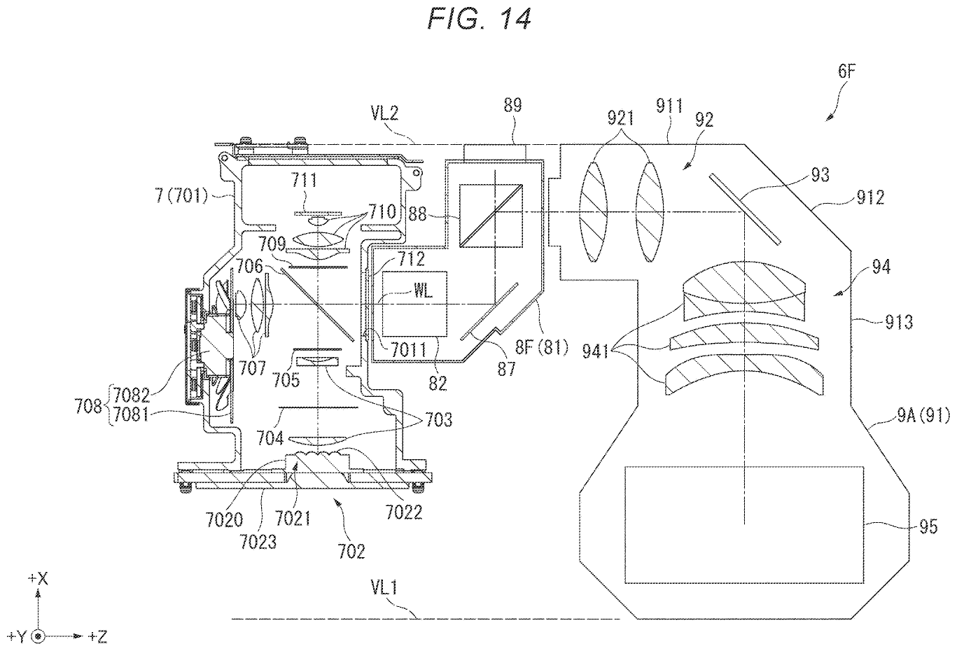

FIG. 14 is a diagrammatic view showing the configuration of an image projection apparatus 6F, which is a fifth variation of the image projection apparatus 6A.

In the image projection apparatus 6A, the image generation apparatus 8A includes the three light modulators 85B, 85G, 85R, which the blue light L1, the green light L2, and the red light L3 separated by the color separation apparatus 83 enter. In contrast, the image generation apparatus may generate the image light by modulating the white light WL incident from the light source apparatus 7 example, the projector 1A may employ the image projection apparatus 6F shown in FIG. 14 in place of the image projection apparatus 6A.

The image projection apparatus 6F has the same configuration and function as those of the image projection apparatus 6A except that the image generation apparatus 8A is replaced with an image generation apparatus 8F. Also when the projector 1A employs the image projection apparatus 6F, the projection optical apparatus 9A s disposed substantially at the center of the exterior enclosure 2A in the direction +Z, and the light source apparatus 7 and the image generation apparatus 8F are disposed in the space SP2 shifted in the direction −Z from the projection optical apparatus 9A.

The image generation apparatus 8F generates image light from the white light WL, which is the illumination light supplied from the light source apparatus 7, as the image generation apparatus 8A does. The image generation apparatus 8F includes the enclosure 81 and the following components accommodated in the enclosure 81: the homogenizer 82; a first reflective optical element 87; a second reflective optical element 88; and an image generator 89. In addition to the above, the image generation apparatus 8F includes a retardation film, a polarizer, and a lens as required.

The first reflective optical element 87 is a reflection mirror. The first reflective optical element 87 reflects in the direction +X the white light WL incident in the direction +Z from the light source apparatus 7 via the homogenizer 82.

The second reflective optical element 88 is disposed in a position shifted in the direction +X from the first reflective optical element 87. The second reflective optical element 88 transmits the white light WL incident in the direction +X from the first reflective optical element 87. The second reflective optical element 88 reflects in the direction +Z the image light modulated by the image generator 89 and incident in the direction −X on the second reflective optical element 88. The reflected image light enters the entrance optical path 92 of the projection optical apparatus 9A. That is, the optical axis of the image light reflected off the second reflective optical element 88 coincides with the optical axis of the entrance optical path 92.

The image generator 89 is disposed in a position shifted in the direction +X from the second reflective optical element 88. The image generator 89 modulates the white light WL incident in the direction +X from the second reflective optical element 88 to generate image light and reflects the image light in the direction −X. The image generator 89 may be a reflective liquid crystal display device, such as an LCOS (liquid crystal on silicon) device or a device using micromirrors, such as a DMD (digital micromirror device).

In the thus configured image projection apparatus 6F, the light exiting optical axis of the light source apparatus 7 is parallel to the light incident optical axis of the projection optical apparatus 9A, as in the image projection apparatus 6A according to the first embodiment. The extension of the light exiting optical axis of the light source apparatus 7 intersects with the optical axis of the passage optical path 94 extending along the direction +X.

The aforementioned arrangement of the light source apparatus 7 and the image generation apparatus 8F can suppress protrusion of the light source apparatus 7 and the image generation apparatus 8F in the direction −X beyond the imaginary line VL1 and protrusion of the light source apparatus 7 and the image generation apparatus 8F in the direction +X beyond the imaginary line VL2.

The projector 1A including the thus configured image projection apparatus 6F can provide the same effects as those provided by the projector 1A including the image projection apparatus 6A.

In the image projection apparatus 6F shown in FIG. 14, the plurality of solid-state light emitters 7021 are disposed as a whole in a position shifted in the direction −X from the diffusive optical element 711, but not necessarily. The solid-state light emitting element 7021 may be disposed as a whole in a position shifted in the +X direction from the diffusive optical element 711, as in the image projection apparatus 6B shown in FIG. 10.

Further, the image projection apparatus 6F may include the projection optical apparatus 9C in place of the projection optical apparatus 9A. In this case, the light source apparatus 7 may be disposed as shown in FIG. 11 or 12.

Furthermore, the light source apparatus 7 of the image projection apparatus 6F may instead be so disposed that the light exiting optical axis of the light source apparatus 7 extends along the direction. +X and the white light WL exits in the direction +X, as shown in FIG. 13. In this case, the homogenizer 82 may be disposed in the light exiting optical axis of the light source apparatus 7, and the first reflective optical element 87 may be omitted.

### Second Embodiment

A second embodiment of the present disclosure will next be described.

The projector according to the present embodiment has the same configuration as that of the projector 1A according to the first embodiment but differs therefrom in terms of the position of the introduction port with which the exterior enclosure is provided and the configuration of the cooler. In the following description, portions that are the same or substantially the same as the portions having been already described have the same reference characters and will not be described.

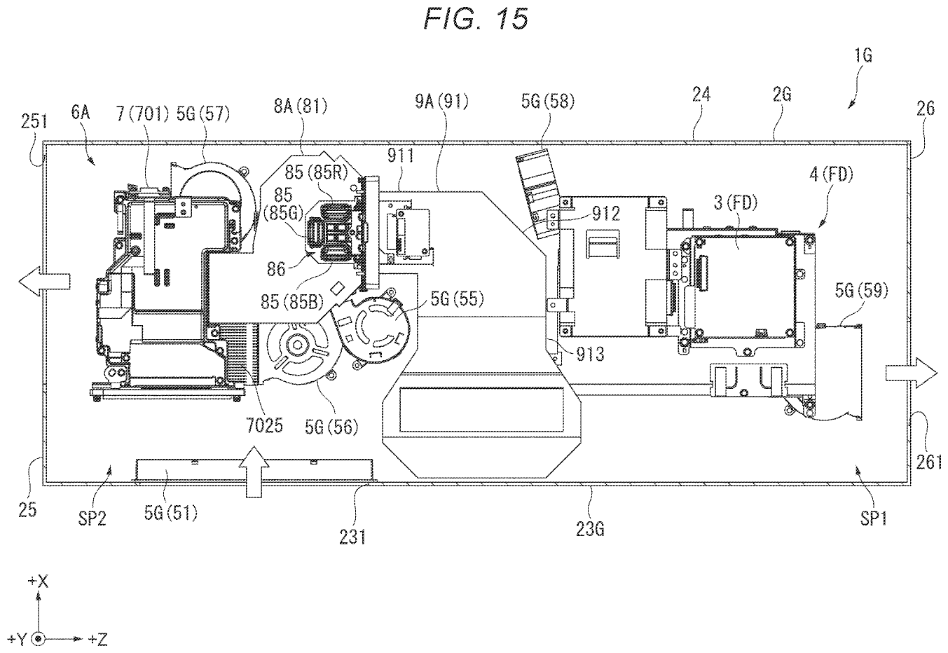

FIG. 15 is a plan view showing the internal configuration of a projector 1G according to the present embodiment. Specifically, FIG. 15 shows the configuration. of the interior of an exterior enclosure 2G of the projector 1G viewed in the direction +Y. In FIG. 15, the heat pipes 7024 are not shown.

The projector 1G according to the present embodiment corresponds to the projection apparatus. The projector 1G has the same configuration and function as those of the projector 1A according to the first embodiment except that the exterior enclosure 2A and the cooler 5A are replaced with the exterior enclosure 2G and a cooler 5G, as shown FIG. 15.

The exterior enclosure 2G has the same configuration and function as those of the exterior enclosure 2A according to the first embodiment except that the front surface 23 is replaced with a front surface 23G.

The front surface 23G has an introduction port 231, which is located in a position shifted in the direction −Z from a central portion of the front surface 23C in the direction +Z. The introduction port 231 corresponds to the first introduction port and introduces the air outside the exterior enclosure 2G as the cooling gas into the exterior enclosure 2G. In detail, the introduction port 231 opens into the space SP2 in the exterior enclosure 2G and introduces the cooling gas into the space SP2.

In the present embodiment, the opening 251 provided at the left side surface 25 functions as a second discharge port, and the opening 261 provided at the right side surface 26 functions as the first discharge port. The cooling gas in the exterior enclosure 2G is discharged via the openings 251 and 261.

The cooler 5G cools the cooling targets provided in the exterior enclosure 2G, as the cooler 5A according to the first embodiment does. The cooler 5G has the same configuration and function as those of the cooler 5A except that the fans 53 and 54 are replaced with fans 58 and 59 and no duct 52 is provided. That is, the cooler 5G includes the filter 51, the fans 55 to 57 provided in the space SP2, and the fans 58 and 59 provided in the space SP1.

The filter 51 is fitted to the introduction port 231 in an attachable and detachable manner.

The fan 58 is provided in the exterior enclosure 25 and located substantially at the center in the direction +Z but shifted in the direction +X. The fan 58 sucks part of the cooling gas introduced into the space SP2 and causes the sucked cooling gas to flow to the controller 3 and the power supply 4, which are provided in positions shifted in the direction +Z from the projection optical apparatus 9A, to cool the controller 3 and the power supply 4. Specifically, the fan 58 sends the cooling gas toward the controller 3 and the power supply 4. The cooling gas sucked from the space SP2 by the fan 58 flows, for example, to the controller 3 and the power supply 4 through the space between the recess 9132 of the lens enclosure 91 and the bottom surface 22 and also flows to the controller 3 and the power supply 4 through the space between the entrance section 911, which corresponds to the entrance optical path 92 in the lens enclosure 91, and the inner surface of the rear surface 24.

The fan 59 is provided in the exterior enclosure 25 and located in a position where the fan 59 faces the opening 261. The fan 59 discharges the cooling gas having cooled the controller 3 and the power supply 4 out of the exterior enclosure 2G via the opening 261.

The fans 55 and 56 in the cooler 5G are disposed in the space between the light source apparatus 7 and the exit section 913, in which the passage optical path 94 is provided, in the exterior enclosure 2G and located in positions shifted in the direction −X from the image generation apparatus 8A, as the fans 55 and 56 in the cooler 5A are.

The fan 55 causes part of the cooling gas introduced into the space SP2 via the introduction port 231 to flow to the light modulation apparatus 85, and the fan 56 causes the other part of the cooling gas introduced into the space SP2 to flow to the heat dissipating member 7025. The light modulation apparatus 85 and the heat dissipating member 7025 are thus cooled.

The fan 57 is disposed in a position shifted in the directions −X and −Z in the exterior enclosure 25 and discharges the cooling gas having cooled the cooling targets out of the exterior enclosure 2G via the opening 251.

The cooler 5G may include a duct that guides part of the cooling gas introduced into the exterior enclosure 2G via the introduction port 231 to the space SP1 from the space SP2. In this case, the duct may be disposed, for example, between the recess 9132 and the inner surface of the bottom surface 22.

The image projection apparatus provided in the projector 1G is not limited to the image projection apparatus 6A and may instead be another image projection apparatus, for example, one of the image projection apparatuses 6B to 6F.

Effects of Second embodiment

The projector 1G as the projection apparatus according to the present embodiment described above can provide the effects below as well as the same effects provided by the projector 1A according to the first embodiment.

In the projector 1G, the introduction port 231 as the first introduction port is provided at the front surface 23G of the exterior enclosure 2G and located at a portion. facing the side where the light source apparatus 7, out of the first apparatus FD and the light source apparatus 7, is disposed. The front surface 23G is one of the outer surfaces of the exterior enclosure 2G having a box-like shape, the outer surface that intersects with the direction +X, which is perpendicular to the direction +Z, in which the light source apparatus 7, the projection optical apparatus 9A, and the first apparatus FD are arranged.

The configuration described above prevents the introduction port 231 from being blocked by objects disposed around the projector 1G. For example, the projector 1G according to the present embodiment is configured as a short-focal-length projector that projects in the direction +X the image light reflected off the optical path changing member 95 of the projection optical apparatus 9A. The projector 1G can therefore be so disposed that the rear surface 24 is close to the projection. receiving surface. On the other hand, providing the introduction port 231 at the front surface 230, which faces away from the rear surface 24, can suppress a decrease in the air introduction efficiency at which the air is introduced via the introduction port 231 when the introduction port 231 is blocked or otherwise obstructed by the projection receiving surface. The cooling gas can therefore be smoothly introduced into the exterior enclosure 2G.

In the projector 1G, the exterior enclosure 20 has the opening 261, which functions as the first discharge port, and the opening 251, which functions as the second discharge port. The opening 251 is provided on the side facing the side where the light source apparatus 7 is disposed, specifically, at the left side surface 25, which is the outer surface that intersects with the direction +Z, in which the light source apparatus 7, the projection optical apparatus 9A, and the first apparatus FD are arranged. The opening 261 is provided on the side facing the side where the first apparatus FD is disposed, specifically, at the right side surface 26, which is the outer surface that intersects with the direction +Z.

According to the configuration described above, the cooling' gas having been introduced into the exterior enclosure 2G via the introduction port 231 and having cooled the light source apparatus 7 can be quickly discharged out of the exterior enclosure 2G via the opening 251. The configuration described above therefore prevents the heated cooling gas from staying inside the exterior enclosure 2G, whereby the temperature of the interior of the exterior enclosure 2G can be lowered.

In the projector 1G, the cooling gas introduced into the exterior enclosure 2G via the introduction port 231 passes through the space between the rear surface 24, which is one of the outer surfaces of the exterior enclosure 2G, the outer surface disposed on the extension of the optical axis of the passage optical path 94, and the entrance section 911, which corresponds to the entrance optical path 92 in the lens enclosure 91.

According to the configuration described above, a channel along which the cooling gas flows in the direction +Z in the exterior enclosure 2G does not need to be separately provided but can be provided between the rear surface 24 and the entrance section 911. The cooling gas is therefore allowed to smoothly flow in the direction

### Third Embodiment

A third embodiment of the present disclosure will next be described.

The projector according to the present embodiment. has the same configuration as that of the projector 1A according to the first embodiment and including the image projection apparatus 6A but differs from the projector 1A in that an introduction port via which the cooling gas is introduced into the exterior enclosure is provided at the bottom surface of the exterior enclosure. In the following description, portions that are the same or substantially the same as the portions having been already described have the same reference characters and will not be described.

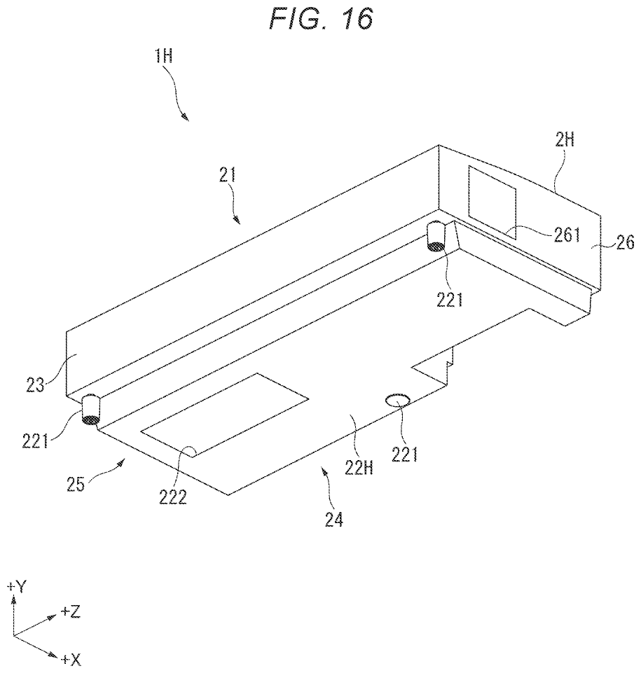

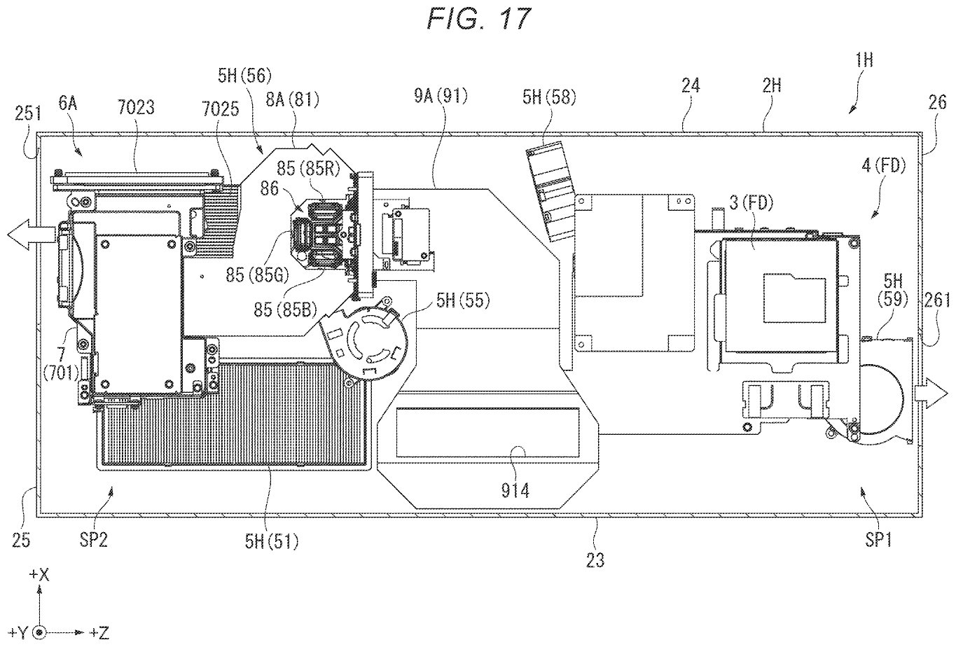

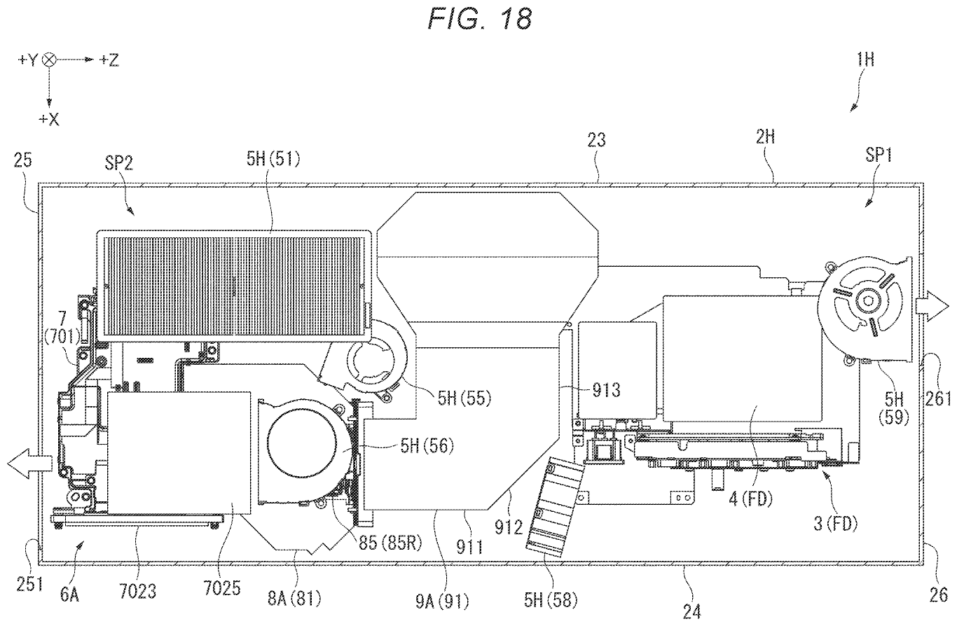

FIG. 16 is a perspective view showing the exterior appearance of a projector 1H according to the present embodiment. In detail, FIG. 16 is a perspective view showing the projector 1H viewed from the side facing a bottom surface 22H. FIG. 17 shows the internal configuration of the projector 1H viewed in the direction +Y, and FIG. 18 shows the internal configuration of the projector 1H viewed in the direction −Y.

The projector 1H according to the present embodiment corresponds to the projection apparatus. The projector 1H has the same configuration and function as those of the projector 1A including the image projection apparatus 6A except that the exterior enclosure 2A and the cooler 5A are replaced with an exterior enclosure 2H shown in FIG. 16 and a cooler 5H shown in FIGS. 17 and 18.

The exterior enclosure 2H has the same configuration and function as those of the exterior enclosure 2A except that the bottom surface 22 is replaced with the bottom surface 22H, as shown in FIG. 16.

The bottom surface 22H is provided with the plurality of legs 221 and has an introduction port 222 as the first introduction port in a position shifted in the directions −X and −Z. The introduction port 222 opens into the space SP2 and introduces the air outside the exterior enclosure 2H as the cooling gas into the space SP2 in the exterior enclosure 2H.

In the present embodiment, the opening 251 provided at the left side surface 25 functions as the second discharge port, and the opening 261 provided at the right side surface 26 functions as the first discharge port. The cooling gas in the exterior enclosure 2H is discharged via the openings 251 and 261.

The cooler 5H is provided in the exterior enclosure 2H and cools the cooling targets in the projector 1H, as shown in FIGS. 17 and 18. The cooler 5H includes the filter 51 and the fans 55, 56, 58, and 59.

The filter 51 is fitted to the introduction port 222 in an attachable and detachable manner.

The fan 55 causes part of the cooling gas introduced into the exterior enclosure 2H via the introduction port 222 to flow to the light modulation apparatus 85 and cool the light modulation apparatus 85.

The fan 56 causes part of the cooling gas introduced into the exterior enclosure 2H via the introduction port 222 to flow to the heat dissipating member 7025 and cool the heat dissipating member 7025. The cooling gas having cooled the heat dissipating member 7025 is discharged out of the exterior enclosure 2H via the opening 251.

The fan 58 causes part of the cooling gas introduced into the space SP2 in the exterior enclosure 2H via the introduction port 222 to flow to the controller 3 and the power supply 4 and cool the controller 3 and the power supply 4. The fan 58 sucks, for example, the cooling gas having flowed in the direction +Z from space SP2 to the recess 9132 (see FIG. 6) of the lens enclosure 91 and the cooling gas having flowed in the direction +Z from space SP2 through the space between the rear surface 24 and the entrance section 911 of the lens enclosure 91.

The fan 59 sucks the cooling gas having cooled the controller 3 and the power supply 4 and discharges the sucked cooling gas out of the exterior enclosure 2H via the opening 261.

The cooler 5H may include a duct that guides part of the cooling gas introduced into the exterior enclosure 2H via the introduction port 222 to the space SP1 from the space 532. In this case, the duct may be disposed, for example, between the recess 9132 (see FIG. 6) , which is provided at the lens enclosure 91 of the projection optical apparatus 9A, and the inner surface of the bottom surface 22H.

The image projection apparatus provided in the projector 1G is not limited to the image projection apparatus 6A and may instead be another image projection. apparatus, for example, one of the image projection apparatuses 6B to 6F.

### Effects of Third Embodiment

The projector 1H as the projection apparatus according to the present embodiment described above can provide the effects below as well as the same effects provided by the projector 1A according to the first embodiment.

The introduction port 222 as the first introduction port is provided at the bottom surface 22H of the exterior enclosure 2H and located at a portion facing the side where the light source apparatus 7, out of the first apparatus FD and the light source apparatus 7, is disposed. The bottom surface 22H is one of the outer surfaces of the exterior enclosure 214, the outer surface that intersects with the direction +Y, which is perpendicular to the direction +Z, in which the light source apparatus 7, the projection optical apparatus 9A, and the first apparatus FD are arranged.

The configuration described above allows the introduction port 222 to be provided at a location that is not noticeable.

### Fourth Embodiment

A fourth embodiment of the present disclosure will next be described.

The projector according to the present embodiment has the same configuration as those of the projectors 1G and 1H according to the second and third embodiments but differs therefrom in that the exterior enclosure has a plurality of introduction ports. In the following description, portions that are the same or substantially the same as the portions having been already described have the same reference characters and will not be described.

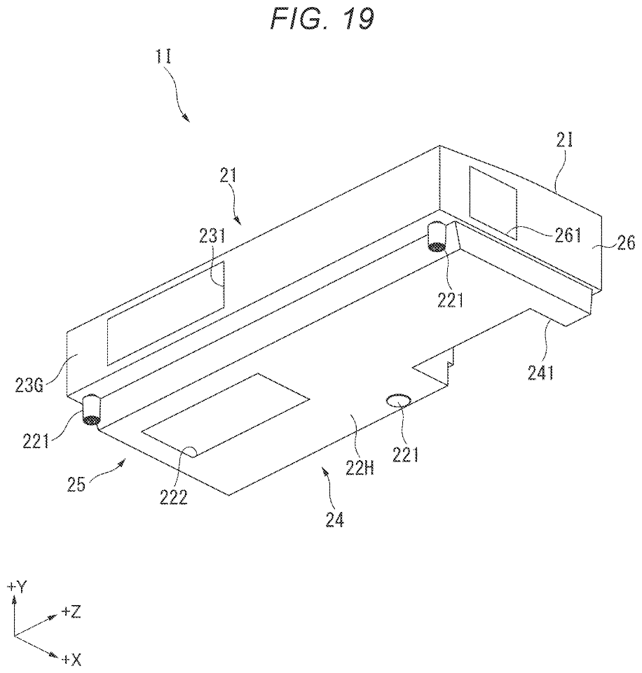

FIG. 19 is a perspective view showing the exterior appearance of a projector 1I according to the present embodiment.

The projector according to the present embodiment 1I has the same configuration and function as those of the projector 1G according to the second embodiment or the projector 1H according to the third embodiment except that the exterior enclosure 2G or 2H is replaced with an exterior enclosure 2I shown in FIG. 19.

The exterior enclosure 21 has the top surface 21, the bottom surface 22H with the introduction port 222, the front surface 230 with the introduction port 231, the rear surface 24, the left side surface 25, and the right side surface 26, and the exterior enclosure 21 has a substantially box-like shape.

One of the introduction ports 222 and 231 is the first introduction port, and the other is the second introduction port. The introduction ports 222 and 231 introduce the air outside the exterior enclosure 2I as the cooling gas into the exterior enclosure 2I. The introduction ports 222 and 231 open into the space SF2 in the exterior enclosure 2I and introduce the air outside the exterior enclosure 2I into the space SP2.

The opening 251 provided at the left side surface 25 functions as the second discharge port, and the opening 261 provided at the right side surface 26 functions as the first discharge port.

### Effects of Fourth Embodiment

The projector 1I as the projection apparatus according to the present embodiment described above can provide the effects below as well as the same effects provided by the projector 1G according to the second embodiment and the projector 1H according to the third embodiment.

When the introduction port 222 provided at the bottom surface 22H is used as the first introduction port, the introduction port 231 as the second introduction port is provided at the front surface 23G, which is one of the outer surfaces of the exterior enclosure 2I, the outer surface facing the light source apparatus 7 with respect to the projection optical apparatus 9A and different from the bottom surface 22H. When the introduction port 231 provided at the front surface 23G is used as the first introduction port, the introduction port 222 as the second introduction port is provided at the bottom surface 22H, which is one of the outer surfaces of the exterior enclosure 2I, the outer surface facing the light source apparatus 7 with respect to the projection optical apparatus 9A and different from the front surface 23G. The introduction ports 222 and 231 introduce the cooling gas flowing to the light source apparatus 7 into the exterior enclosure 2I.

The configuration described above allows the cooling gas to be readily introduced into the exterior enclosure 21 and further allows the cooling gas having a low temperature to flow to the cooling targets, such as the light source apparatus 7. The efficiency of the cooling of the cooling targets can therefore be increased.

### Variations of Embodiments

The present disclosure is not limited to the embodiments described above, and variations, improvements, and other modifications to the extent that the advantage of the present disclosure is achieved fall within the scope of the present disclosure.

In each of the embodiments described above, the first apparatus FD, which is disposed on the opposite side of the projection optical apparatus 9A or 9C from the light source apparatus 7, is the controller 3 and the power supply 4. In other words, in each of the embodiments described above, the first apparatus FD is formed of the controller 3 and the power supply 4, but not necessarily. The first apparatus FD may be formed only of the controller 3 or only the power supply 4. When the first apparatus FD is the controller 3, the power supply 4 may be disposed in a position shifted in one of the directions −Z, ±X, and ±Y from the projection optical apparatus 9A or 9C. When the first apparatus FD is the power supply 4, the controller 3 may be disposed in a position shifted in one of the directions −Z, ±X, and ±Y from the projection optical apparatus 9A or 9C.

In each of the embodiments described above, the light source apparatus 7 is disposed in a position shifted in the direction −Z from the projection optical apparatus 9A or 9C, and the first apparatus FD is disposed in a position shifted in the direction +Z from the projection optical apparatus 9A or 9C, but not necessarily. The light source apparatus 7 and the first apparatus FD only need to be disposed on opposite sides of the projection optical apparatus 9A or 9C, and the positions of the light source apparatus 7 and the first apparatus PD may not necessarily be on opposite sides of the direction +Z.

In the first embodiment described above, the opening 261, which functions as the first introduction port, and the opening 251, which functions as the first discharge port, are provided at the right side surface 26 and the left side surface 25, respectively, which are the outer surfaces that intersect with the direction +Z, in which the light source apparatus 7, the projection optical apparatus 9A or 9C, and the first apparatus FD are arranged. In the second embodiment described above, the introduction port 231, which functions as the first introduction port, is provided at the front surface 23G, which intersects with the direction +X, which is perpendicular to the direction +Z, the opening 251 functions as the second discharge port, and the opening 261 functions as the first discharge port. In the third embodiment described above, the introduction port 222, which. functions as the first introduction port, is provided at the bottom surface 22H, which intersects with the direction +Y, which is perpendicular to the direction +Z, the opening 251 functions as the second discharge port, and the opening 261 functions as the first discharge port. In the fourth embodiment described above, one of the introduction port 231 provided at the front surface 23G and the introduction port 222 provided at the bottom surface 22H is the first introduction port and the other is the second introduction port, the opening 251 functions as the second discharge port, and the opening 261 functions as the first discharge port, but not necessarily.

The introduction ports may each be provided at another outer surface of the exterior enclosure, and the exhaust ports may each of be provided at another outer surface in the exterior enclosure. That is, in the exterior enclosure, the number of introduction ports and the positions thereof and the number of the discharge ports and the positions thereof can be changed as appropriate. For example, any of the introduction ports may be provided at an outer surface facing the first apparatus, as in the exterior enclosure 2A. Furthermore, for example, an introduction port and a discharge port may be provided at one of outer surfaces of the exterior enclosure, an outer surface facing the first apparatus, and an introduction port and a discharge port may be provided at one of the outer surfaces of the exterior enclosure, an outer surface facing the light source apparatus, so that the cooling targets in the space SP1 may be cooled by the cooling gas introduced into the space SP1, and the cooling targets in the space SP2 may be cooled by the cooling gas introduced into space SP2. In this case, in the exterior enclosure, the outer surface where an introduction port is provided may be the same as or may differ from the outer surface where a discharge port is provided.

In each of the embodiments described above, the lens enclosure 91 of the projection optical apparatus 9A or 9C has the recess 9132 at the exit section 913, which is the portion according to the passage optical path 94, but not necessarily. The recess 9132 may be omitted. In this case, the cooling gas flowing through the interior of the exterior enclosure may flow in the direction ±Z so as not to flow to the projection optical apparatus 9A or 9C.

The position of the recess 9132 is not limited to a position shifted in the direction −Y from the exit section 913 and may instead be a position shifted in the direction +Y from the exit section 913.

In each of the embodiments described above, the light source apparatus 7 includes the solid-state light emitters 7021, the wavelength converter 7081, and the diffusive optical element 711, but not necessarily. The light source apparatus 7 may be configured to include a light source lamp, such as an ultrahigh-pressure mercury lamp, or include a solid-state light emitter that emits the blue light L1, a solid-state light emitter that emits the green light L2, and a solid-state light emitter that emits the red light L3. The layout of the optical parts that form the light source apparatus 7 is not limited to the layout described above and can be changed as appropriate.

In each of the embodiments described above, the wavelength converter 7081 is rotated by the rotator 7082, but not necessarily. The wavelength converter 7081 may not to be rotated. That is, the rotator 7082 may be omitted.

In each of the embodiments described above, the wavelength converter 7081 is disposed on the extension of the light exiting optical axis of the light source apparatus 7. The diffusive optical element 711 is disposed so as to face the solid-state light emitters 7021 so that the optical axis of the diffusive optical element 711 coincides with the optical axis of the entire solid-state light emitters 7021, and the optical axis of the entire solid-state light emitters 7021 and the optical axis of the diffusive optical element 711 are perpendicular to the optical axis of the wavelength converter 7081, which coincides with the extension of the light exiting optical axis of the light source apparatus 7, at the light combiner 706. However, the configuration described above is not necessarily employed, and the wavelength converter 7081 and the diffusive optical element 711 may be swapped. That is, the diffusive optical element 711 may be disposed on the extension of the light exiting optical axis of the light source apparatus 7, and the wavelength converter 7081 may be disposed so as to face the solid-state light emitters 7021 so that the optical axis of the wavelength converter 7081 coincides with the optical axis of the entire solid-state light emitters 7021. In this case, the optical axis of the entire solid-state light emitters 7021 and the optical axis of the wavelength converter 7081 are perpendicular to the optical axis of the diffusive optical element 711 at the light combiner 706.

In each of the embodiments described above, the light source section 702 includes the heat receiving member 7023, which is provided on the opposite side of the solid-state light emitters 7021 from the light emitting side thereof and receives the heat of the solid-state light emitters 7021, but not necessarily. The heat receiving member 7023 may be omitted in this case, the heat pipes 7024 may be coupled to the support member 7020.

In each of the embodiments described above, the light source section 702 includes the heat dissipating member 7025, which is coupled to the heat receiving member 7023 in a heat transferable manner, but not necessarily. The heat dissipating member 7025 may be omitted. The heat dissipating member 7025 may not be provided in the vicinity of the solid-state light emitters 7021, and the location of the heat dissipating member 7025 can be changed as appropriate.

In each of the embodiments described above, the light source section 702 includes the heat pipes 7024, which couple the heat receiving member 7023 to the heat dissipating member 7025 in a heat transferable manner. The heat pipes 7024 may, however, be omitted. In this case, the heat dissipating member 7025 may be directly coupled to the heat receiving member 7023.

In each of the embodiments described above, the fans 54 and 55 are provided between the light source apparatus 7 and the exit section 913 of the projection optical apparatus 9A or 9C the direction +Z, but not necessarily. The fans provided between the light source apparatus 7 and the exit section 913 in the direction +Z may be omitted, or the number of fans provided in the exterior enclosure and the positions of the fans are not limited to those described above.

In each of the embodiments described above, the projection optical apparatus 9A or 9C includes the optical path changing member 95, which reflects in the directions +X and +Y the image light having traveled in the direction −X along the passage optical path reverse the traveling direction of the image light, but not necessarily. The optical path changing member 95 may be omitted. That is, the projection optical apparatus 9A or 9C may project in the direction −X the image light having traveled along the passage optical path 94.

In each of the embodiments described above, the light modulation apparatus 85 includes the three light modulators 85B, 85G, and 85R, but not necessarily. The number of light modulators provided in the light modulation apparatus is not limited to three and can be changed as appropriate.

The light modulators 85B, 85G, and 85R are each a transmissive liquid crystal panel having a light incident surface and a light exiting surface different from each other, but not necessarily. The light modulators may each be a reflective liquid crystal panel having a surface that serves both as the light incident surface and the light exiting surface. Further, a light modulator using any component other than a liquid-crystal-based component and capable of modulating an incident light flux to form an image according to image information, such as a device using micromirrors, for example, a DMD, may be employed.

In the fifth variation of the first embodiment described above, the second reflective optical element 88 transmits in the direction +X the white light WL incident from the first reflective optical element 87 and reflects in the direction +Z the image light incident from the image generator 89, but not necessarily. The second reflective optical element 88 may instead be configured to reflect in the direction −Z the white light WL incident in the direction +X from the first reflective optical element 87 and transmit in the direction +Z the image light incident from the image generator 89. In this case, the image generator 89 may be disposed in a position shifted in the direction −Z from the second. reflective optical element 88. Instead, the second reflective optical element 88 may be configured to reflect in the direction −Y or +Y the white light WL incident in the direction +X from the first reflective optical element 87 and reflect in the direction +Z the image light incident from the image generator 89. In this case, the image generator 89 may be disposed in a position shifted in the direction −Y or +Y from the second reflective optical element 88.

In the embodiments described above, the projectors 1A, 1G, 1H, and 1I, which each project image light to display an image, are illustrated as the projection apparatus by way of example, but not necessarily. The projection apparatus according to the present disclosure may be any apparatus that projects light and is not necessarily limited to an apparatus that projects image light.

### Overview of Present Disclosure

The present disclosure will be summarized below as additional remarks.

A projection apparatus according to an aspect of the present disclosure includes a projection optical apparatus having an entrance optical path that image light enters and a passage optical path that is a deflected extension of the entrance optical path, an image generation apparatus that causes the image light to enter the entrance optical path, a light source apparatus that supplies the image generation apparatus with illumination light, and a first apparatus disposed on the opposite side of the projection optical apparatus from, the light source apparatus, and the first apparatus is at least one of a controller and a power supply.

It is assumed that the direction along the optical axis of the passage optical path is a first direction, the direction in which the light source apparatus, projection optical apparatus, and first apparatus are arranged is a second direction, and the direction that intersects with each of the first and second directions is a third direction.

The configuration described above, in which the projection optical apparatus has the entrance optical path and the passage optical path, which is a deflected extension of the entrance optical path, allows reduction in the dimension of the projection apparatus in the first direction. Furthermore, since the light source apparatus and the image generation apparatus do not overlap with the first apparatus in the third direction, the dimension of the projection apparatus in the third direction can be reduced. The projection apparatus can therefore be made compact.

In the aspect described above, the projection apparatus may include an exterior enclosure that forms the exterior of the projection apparatus. The projection optical apparatus may include a projection optical apparatus enclosure that accommodates the entrance optical path and the passage optical path. The exterior enclosure may have a first introduction port provided at a portion facing the side where one of the first apparatus and the light source apparatus is disposed and a first discharge port provided at a portion facing the side where the other of the first apparatus and the light source apparatus is disposed. The air introduced into the exterior enclosure via the first introduction port may pass through the space between the exterior enclosure and a portion of the projection optical apparatus enclosure that is the portion according to the passage optical path.

The configuration described above allows the air introduced into the exterior enclosure via the first introduction port to be discharged out of the exterior enclosure via the first discharge port after the air is caused to flow via the first apparatus and the light source apparatus. The first apparatus and the light source apparatus can thus be efficiently cooled.

The air introduced into the exterior enclosure via the first introduction port passes through the space between the exterior enclosure and a portion of the projection optical apparatus enclosure, which separates the space facing the light source apparatus from the space facing the first apparatus, that is the portion according to the passage optical path. The air can thus be readily caused to flow from one of the space facing the first apparatus and the space facing the light source apparatus to the other space. The air can therefore be readily caused to flow through the interior of the exterior enclosure, whereby the efficiency of the cooling of the light source apparatus and the first apparatus can be increased.

In the aspect described above, the first introduction port may be provided at one of outer surfaces of the exterior enclosure that intersect with the direction in which the light source apparatus, the projection optical apparatus, and the first apparatus are arranged, the outer surface facing the first apparatus and the outer surface facing the light source apparatus.

The configuration described above allows the air outside the exterior enclosure to be readily introduced into the exterior enclosure via the first introduction port. The air can therefore be readily caused to flow to the first apparatus and the light source apparatus in the exterior enclosure, whereby the efficiency of the cooling of the first apparatus and the light source apparatus can be increased.

In the aspect described above, the first introduction port described above may be provided at a portion of an outer surface of the exterior enclosure that intersects with a direction perpendicular to the direction in which the light source apparatus, the projection optical apparatus, and the first apparatus are arranged, the portion facing the side where one of the first apparatus and the light source apparatus is disposed.

According to the configuration described above, for example, when the first introduction port is provided at the outer surface corresponding to the bottom or rear surface of the exterior enclosure, the first introduction port can be provided at a hardly noticeable location.

In the aspect described above, the exterior enclosure may have a second discharge port provided at an outer surface that intersects with the direction in which the light source apparatus, the projection optical apparatus, and the first apparatus are arranged and located on the side where one of the first apparatus and the light source apparatus is disposed.

According to the configuration described above, the second discharge port is provided at an cuter surface of the exterior enclosure and located in a position shifted to the first introduction port from the projection optical apparatus. Therefore, when the first apparatus or the light source apparatus is cooled by part of the air introduced into the exterior enclosure via the first introduction port, the air having cooled the first apparatus or the light source apparatus can be quickly discharged out of the exterior enclosure via the second discharge port. The configuration described above therefore prevents the heated air from staying inside the exterior enclosure, whereby the temperature of the interior of the exterior enclosure can be lowered.

In the aspect described above, the exterior enclosure may have a first outer surface that intersects with a direction that intersects with the passage optical path and further intersects with the direction in which the light source apparatus, the projection optical apparatus, and the first apparatus are arranged. The projection. optical apparatus enclosure may have, at a portion corresponding to the passage optical path, a first portion separate by a small distance from the first outer surface and a second portion separate by a large distance from the first outer surface. The air introduced into the exterior enclosure via the first introduction port may pass through the space between the first outer surface and the second portion.

According to the configuration described above, a channel along which the air flows in the second direction or in the direction opposite to the second direction in the exterior enclosure can be provided in the projection optical apparatus enclosure. The air can therefore be smoothly caused to flow in the second direction or in the direction opposite to the second direction.

In the aspect described above, the air introduced. into the exterior enclosure via the first introduction port may pass through the space between one of the outer surfaces of the exterior enclosure that is the outer surface disposed on the extension of the optical axis of the passage optical path and a portion of the projection optical apparatus enclosure that is the portion corresponding to the entrance optical path.

According to the configuration described above, a channel along which the air flows in the second direction or in the direction opposite to the second direction in the exterior enclosure can be provided between the outer surface disposed on the extension of the optical axis of the passage optical path and the projection optical apparatus enclosure. The air can therefore be smoothly caused to flow in the second direction or in the direction opposite to the second direction.

In the aspect described above, the exterior enclosure may have a second introduction port at an outer surface that faces the light source apparatus with respect to the projection optical apparatus and differs from the outer surface provided with the first discharge port to introduce the air flowing to the light source apparatus into the exterior enclosure.

The configuration described above allows the air outside the exterior enclosure to be readily introduced into the exterior enclosure and further allows the cooling gas having a low temperature to flow to the cooling targets, such as the light source apparatus. The efficiency of the cooling of the cooling targets can therefore be increased.

In the aspect described above, a fan may be provided between the passage optical path and the light source apparatus.

According to the configuration described above, the fan can be disposed in a region that is likely to form a dead space in the projection apparatus. The parts that form the projection apparatus can therefore be disposed therein in a packed manner, whereby the dimensions of the projection apparatus can be reduced, so that the projection apparatus can be made compact.

In the aspect described above, the light source apparatus may include a light source and a heat dissipating member to which the heat of the light source is transferred, and the heat dissipating member may be provided in a position shifted in the direction perpendicular to the direction in which the light source apparatus, the projection optical apparatus, and the first apparatus are arranged and to the passage optical path.

According to the configuration described above, the heat dissipating member can increase the heat dissipation area via which the heat of the light source is dissipated. The heat dissipation efficiency in accordance with which the heat generated by the light source is dissipated can therefore be further increased.

Furthermore, providing the heat dissipating member in a position shifted in the third direction from the light source allows the projection apparatus to be compact in the first direction as compared with a case where the heat dissipating member is provided in a position. shifted in the first direction from the light source.

What is claimed is:

1. A projection apparatus comprising:
a projection optical apparatus having an entrance optical path that image light enters and a passage optical path that is a deflected extension of the entrance optical path;
an image generation apparatus that causes the image light to enter the entrance optical path;
a light source apparatus that supplies the image generation apparatus with illumination light; and
a first apparatus disposed on an opposite side of the projection optical apparatus from the light source apparatus,
wherein the first apparatus is at least one of a controller and a power supply.

2. The projection apparatus according to claim 1,
further comprising an exterior enclosure that forms an exterior of the projection apparatus,
wherein the projection optical apparatus includes a projection optical apparatus enclosure that accommodates the entrance optical path and the passage optical path,
the exterior enclosure has
a first introduction port provided at a portion facing a side where one apparatus of the first apparatus and the light source apparatus is disposed, and
a first discharge port provided at a portion facing a side where another apparatus of the first apparatus and the light source apparatus is disposed, and
air introduced into the exterior enclosure via the first introduction port passes through a space between the exterior enclosure and a portion of the projection optical apparatus enclosure that is a portion according to the passage optical path.

3. The projection apparatus according to claim 2,
wherein the first introduction port is provided at one of outer surfaces of the exterior enclosure that intersect with a direction in which the light source apparatus, the projection optical apparatus, and the first apparatus are arranged with one outer surface facing the first apparatus and another outer surface facing the light source apparatus.

4. The projection apparatus according to claim 2,
wherein the first introduction port is provided at a portion of an outer surface of the exterior enclosure that intersects with a direction perpendicular to a direction in which the light source apparatus, the projection optical apparatus, and the first apparatus are arranged, the portion facing a side where one of the first apparatus and the light source apparatus is disposed.

5. The projection apparatus according to claim 4,
wherein the exterior enclosure has a second discharge port provided at a portion of an outer surface that intersects with the direction in which the light source apparatus, the projection optical apparatus, and the first apparatus are arranged, the portion facing the side where one of the first apparatus and the light source apparatus is disposed.

6. The projection apparatus according to claim 2,
wherein the exterior enclosure has a first outer surface that intersects with a direction that intersects with the passage optical path and further intersects with a direction in which the light source apparatus, the projection optical apparatus, and the first apparatus are arranged,
the projection optical apparatus enclosure has, at a portion corresponding to the passage optical path, a first portion separate by a small distance from the first outer surface and a second portion separate by a large distance from the first outer surface, and
the air introduced into the exterior enclosure via the first introduction port passes through a space between the first outer surface and the second portion.

7. The projection apparatus according to claim 6,
wherein the first outer surface is a bottom surface of the exterior enclosure.

8. The projection apparatus according to claim 2,
wherein the air introduced into the exterior enclosure via the first introduction port passes through a space between one of outer surfaces of the exterior enclosure that is an outer surface disposed on an extension of an optical axis of the passage optical path and a portion of the projection optical apparatus enclosure that is a portion corresponding to the entrance optical path.

9. The projection apparatus according to claim 2,
wherein the exterior enclosure has a second introduction port at an outer surface that faces the light source apparatus with respect to the projection optical apparatus and differs from an outer surface provided with the first discharge port to introduce the air flowing to the light source apparatus into the exterior enclosure.

10. The projection apparatus according to claim 1,
further comprising a fan provided between the passage optical path and the light source apparatus.

11. The projection apparatus according to claim 1,
wherein the light source apparatus includes
a light source, and
a heat dissipating member to which heat of the light source is transferred, and
the heat dissipating member is provided in a position shifted in a direction perpendicular to a direction in which the light source apparatus, the projection optical apparatus, and the first apparatus are arranged and to the passage optical path.

12. The projection apparatus according to claim 1,
wherein a light exiting optical axis along which the light exits via an exit port of the light source apparatus is parallel to an optical axis of the entrance optical path of the projection optical apparatus, and
an extension of the light exiting optical axis of the light source apparatus intersects with an extension of an optical axis of the passage optical path of the projection optical apparatus.
